(19) United States
(12) Patent Application Publication
(10) Pub. No.: US 2026/0141412 A1
(43) Pub. Date: May 21, 2026

(54) EFFICIENT ALGORITHM FOR COMPUTATION OF DECAY VELOCITY ON DISTRIBUTED COMPUTING SYSTEMS

(71) Applicant: MASTERCARD INTERNATIONAL INCORPORATED, Purchase, NY (US)

(72) Inventors: Bahman Sheikh, Lake Saint Louis, MO (US); Sayed Amin Afzal, Chesaterfield, MO (US)

(21) Appl. No.: 18/952,840

(22) Filed: Nov. 19, 2024

(51) Int. Cl. G06Q 30/0202; G06F 17/11

(52) U.S. Cl. CPC G06Q 30/0202; G06F 17/11

(57) ABSTRACT

A computer system for efficient computation of decay velocity in a distributed computing system. The computer system includes a memory device in communication with a processor. The processor is programmed to receive transaction information of transactions of one or more cardholders within a payment network. The transaction information includes data relating to purchases made by the cardholders at one or more merchants. The computer system determines a decay velocity of the transactions based on one or more time quantities without the need to separately group and sort dimensions of the transactions.

### BACKGROUND OF THE DISCLOSURE

The field of the disclosure relates generally to improving the efficiency of computations within large, distributed computing systems, and more specifically to efficient algorithms for parallel computation of decay velocity within large, distributed computing systems.

Decay velocity involves analyzing the rate at which a certain activity occurs (e.g., decreases) over time. For example, the rate of decay or decay velocity of a sample of a radioactive substance is the decrease in the number of radioactive nuclei per unit of time. A velocity engine is a computational tool or algorithm designed to analyze and predict the rate at which certain events or values, such as transaction velocities, decay over time, and utilize decay velocity formulas as part of such analysis and prediction. Velocity engines and decay velocity calculations are used across a variety of industries for various purposes. These industries include finance, manufacturing, telecommunications, healthcare, and transportation and logistics. These engines and calculations leverage advanced algorithms and real-time data analysis to improve efficiency, safety, and performance. A few key aspects of a velocity engine include: (i) data collection, where the engine collects data on (e.g., transaction) velocities over time, (ii) analysis, where the engine analyzes the rate at which these velocities change or decay, (iii) prediction, where the engine predicts future velocities based on historical data, and (iv) alerting, where the engine can provide alerts for unusual patterns that may indicate abnormal activity.

For example, in the finance industry, velocity engines can be used for aspects such as analyzing the speed of transactions and the decay of asset values over time, which may help in risk management and in developing other strategies. Within the manufacturing industry, velocity engines may be configured to track the speed of production lines, where a sudden increase or decrease in the velocity of a production line could indicate a problem that needs attention. In the payments industry, for example, payment institutions may use decay velocity calculations to assess the risk associated with certain transactions. By analyzing how transaction velocities change over time, they can predict potential fraud or financial instability. In the payment card industry, systems designed to enhance the performance and management of payment card transactions and services may be utilized, where decay velocities can be leveraged in authentication, authorization and fraud detection. This may include monitoring if a payment card is used more frequently than usual, in multiple locations within a short period of time, or for amounts outside of a normal spending threshold. In such a case, the engine can identify such unusual patterns and/or flag such transactions as potentially fraudulent and take action to prevent unauthorized use. For example, a sudden drop in transaction activity after a burst of high activity could be flagged as suspicious behavior, triggering additional investigation and/or causing subsequent transactions to be declined.

However, efficiently computing decayed velocities for massive datasets comprising hundred-billions of transactions presents a formidable challenge. The exponential nature of decay calculations necessitates sequential processing with a dependency to the last transaction velocity. Processing large datasets sequentially using a conventional decay equation is time-consuming, requires a great deal of computational resources and memory and is inefficient, particularly when the data volume exceeds the capacity of a single machine, prompting the utilization of distributed computing systems.

Distributed computing systems and techniques are helpful in easing the processing burden of such large datasets. Distributed computing systems (e.g., distributed computing clusters) are groups of interconnected computers that work together to perform complex computational tasks. These clusters are designed to function as a single system, providing enhanced computational power and reliability. A few key aspects of distributed computing clusters include: (i) structure, e.g., a cluster typically consists of multiple computers (nodes) connected via a high-speed local area network (LAN) or wide area network (WAN), and each node may run its own instance of an operating system; (ii) coordination, e.g., the nodes in a cluster are coordinated by clustering middleware, which allows them to work together seamlessly (the middleware may manage the distribution of tasks and ensure that the cluster operates as a cohesive unit); (iii) scalability, e.g., one of the main advantages of distributed computing clusters is their scalability (ability to add more nodes to the cluster as needed to handle increased workloads); (iv) fault tolerance, e.g., clusters are designed to be fault-tolerant (if one node fails, the others can continue to operate, ensuring that the system remains available and reliable); and (v) cost-effectiveness, e.g., compared to single high-performance computers, clusters are often more cost-effective (off-the-shelf hardware can be used and scaled out as needed).

However, even in known distributed computing system frameworks, intrinsic sequential constraints hold back an efficient parallel velocity computation. For example, identifying data with dimension/dimension key identifiers can help to organize, retrieve, and/or process data efficiently. But the requirement to calculate velocities for each dimension/dimension key further complicates the process, necessitating additional (e.g., data) shuffling and grouping operations.

What is needed is an efficient algorithm for parallel computation of decay velocity within distributed computing systems, addressing the complexities of processing gigantic datasets containing hundred-billions of transactions by improving data partitioning and dependency reduction, thereby streamlining the process, and enhancing efficiency and scalability.

### BRIEF DESCRIPTION OF THE DISCLOSURE

In one embodiment, a computer system for calculating a decay velocity. The computer system includes: one or more storage devices including one or more partitions defined therein; and a computing device comprising at least one processor in communication with at least one memory device and the one or more storage devices. The at least one processor is programmed to: receive transaction data for one or more transactions of a cardholder initiated using a payment processing network; process the transaction data for the one or more transactions by mapping the transaction data within the one or more partitions including: assign an identification (ID) to each transaction of the one or more transactions; generate a dataset based on the assigned IDs; arrange the dataset into a plurality of subsets within the one or more partitions, wherein each subset of the plurality of subsets represents a range of the assigned IDs; calculate a sum of a selected dimension key present in each partition of the one or more partitions; calculate an accumulated sum by combining each sum of the selected dimension key in each partition; compute one or more decay velocities of the accumulated sum for the selected dimension key; and output the one or more decay velocities for the selected dimension key representing the one or more transactions.

In another embodiment, a computer-implemented method is provided for calculating a decay velocity implemented using at least one processor in communication with at least one memory. The method includes: defining one or more partitions in the at least one memory; receiving transaction data for one or more transactions of a cardholder initiated using a payment processing network; processing the transaction data for the one or more transactions by mapping the transaction data within the one or more partitions including: assigning an identification (ID) to each transaction of the one or more transactions; generating a dataset based on the assigned IDs; arranging the dataset into a plurality of subsets within the one or more partitions, wherein each subset of the plurality of subsets represents a range of the assigned IDs; calculating a sum of a selected dimension key present in each partition of the one or more partitions; calculating an accumulated sum by combining each sum of the selected dimension key in each partition; computing one or more decay velocities of the accumulated sum for the selected dimension key; and outputting the one or more decay velocities for the selected dimension key representing the one or more transactions.

In yet another embodiment, one or more non-transitory computer-readable storage media with instructions stored thereon that, in response to being executed, cause a computer system for calculating a decay velocity to: define one or more partitions in one or more storage devices; receive transaction data for one or more transactions of a cardholder initiated using a payment processing network; process the transaction data for the one or more transactions by mapping the transaction data within the one or more partitions including: assign an identification (ID) to each transaction of the one or more transactions; generate a dataset based on the assigned IDs; arrange the dataset into a plurality of subsets within the one or more partitions, wherein each subset of the plurality of subsets represents a range of the assigned IDs; calculate a sum of a selected dimension key present in each partition of the one or more partitions; calculate an accumulated sum by combining each sum of the selected dimension key in each partition; compute one or more decay velocities of the accumulated sum for the selected dimension key; and output the one or more decay velocities for the selected dimension key representing the one or more transactions.

### BRIEF DESCRIPTION OF THE DRAWINGS

FIGS. 1-14 show exemplary embodiments of the methods and systems described herein.

FIG. 1 is a schematic diagram illustrating an example multi-party payment processing system for enabling payment transactions used in conjunction with an efficient algorithm for computation of decay velocity on distributed computing clusters in accordance with one embodiment of the present disclosure.

FIG. 2 is a simplified block diagram of an example computer system representative of a velocity analysis computing system in the payment processing environment shown in FIG. 1.

FIG. 3 is a table listing an example embodiment of a formula for calculating decay velocity according to the present disclosure.

FIG. 4 is a diagram illustrating an example embodiment of data partitioning in accordance with the example embodiment shown in FIG. 3.

FIG. 5 is a diagram illustrating an example embodiment of grouping and counting transactions and dimensions in accordance with the example embodiment shown in FIGS. 3 and 4.

FIG. 6 a diagram illustrating an example embodiment of data aggregation in accordance with the example embodiment shown in FIGS. 3-5.

FIG. 7 is a table listing another example embodiment of a formula for calculating decay velocity according to the present disclosure.

FIG. 8 is a diagram illustrating an example embodiment of data partitioning in accordance with the example embodiment shown in FIG. 7.

FIG. 9 is a diagram of an example data flow that may be used in the velocity analysis computing system of the present disclosure and the example embodiment shown in FIGS. 7 and 8.

FIG. 10 is an example configuration of the velocity analysis computing system of the present disclosure.

FIG. 11 is an example configuration of a server and/or client computing device of the present disclosure.

FIG. 12 is an example configuration of a user computing device of the present disclosure.

FIG. 13 illustrates a process flow for an example method for calculating decay velocity using the velocity analysis computing system of the present disclosure for the example embodiment shown in FIGS. 3-6.

FIG. 14 illustrates a process flow for a second example method for calculating decay velocity using the velocity analysis computing system of the present disclosure for the example embodiment shown in FIGS. 7-9.

Like numbers in the Figures indicate the same or functionally similar components. Although specific features of various embodiments may be shown in some figures and not in others, this is for convenience only. Any feature of any figure may be referenced and/or claimed in combination with any feature of any other figure.

### DETAILED DESCRIPTION OF THE DISCLOSURE

The following detailed description illustrates embodiments of the present disclosure by way of example and not by way of limitation. The description enables one skilled in the art to make and use the disclosure, describes several embodiments, adaptations, variations, alternatives, and uses of the disclosure, including what is presently believed to be the best mode of carrying out the disclosure. The disclosure is described as applied to an example embodiment, namely, methods and systems for an efficient algorithm for computation of decay velocity on distributed computing systems (e.g., distributed computing clusters).

The present disclosure provides an efficient and improved algorithm for parallel computation of decay velocity within distributed computing systems, addressing the complexities of processing gigantic datasets containing hundred-billions of transactions, which further includes innovations in data partitioning and dependency reduction that streamline the calculation process, enhancing efficiency and scalability. Because of the variety of transaction types and the sheer volume of transactions, it is much too time consuming and requires significant computer resources to analyze an entire database of historical transactions for a particular card number (account) when new transaction data is received each time. The decay velocities and processes described herein are therefore utilized to extract useful information without requiring analysis of an entire transaction history. Decay time refers to the period over which the value or relevance of a transaction diminishes. A longer decay time indicates a slower rate of decay, meaning the transaction retains its value or relevance for a longer period.

Decay velocities can be leveraged across authentication and authorization fraud detection models and decision-making processes for processing payment transactions, where velocity engines are utilized on a daily basis in connection with consumer payment card transactions. This may include additional monitoring of a payment card when the payment card is used more frequently than usual or in multiple locations within a short period. In such a case, the velocity engine may flag these transactions as potentially fraudulent and take action to prevent unauthorized use. For example, for transactions that may be utilized over a period of time for fraud or modeling, more weight may be given to more recent transactions. A transaction from two days ago may be weighted more heavily than a transaction from two weeks ago, which may be weighted more heavily than a transaction from two months ago. The further back in time, the more decay, and the less impact on, for example, fraud modeling.

In one example, transaction data may be saved when a transaction is completed including a transaction amount and a time associated with the transaction (e.g., timestamp). For example, one velocity may be set or calculated for monitoring U.S. dollar amounts (including other aspects that such a category may entail) as part of determining an overall behavior profile of a particular cardholder and/or card number(s) of the cardholder. In one sample period, a cardholder may generally have a transaction (e.g., last month) for $5 and then next week $10, then $5 again, and so on. It is desired to flag the current transaction or the recent transactions, and to detect if there is error, or a suspicious transaction, or a valid transaction, and there may be different velocities for each.

In the above example, if the decay velocity is large, the quantity of transactions has likely decreased. There may be an order velocity for the accounts, which means the number of transactions in a particular time period. Dividing these quantities relative to the time period enables determination of average transactions within the (e.g., time) period, to be derived so as to avoid having to go through all the historical transaction data and calculate these average transactions whenever a new transaction for a card number is received. Using a combination of different velocities to calculate a specific statistical parameter such as an average, for example, can be performed if it is desired to calculate the U.S. dollar amount average for a card number (as opposed to not using velocities, in which case all U.S. dollar transactions would need to be analyzed and then divided by the total number of transactions). The velocity techniques described herein provide for finding an average of U.S. dollar transactions while weighting the recent transactions more heavily, and the ability to not have to store entire transaction histories in storage systems in order to calculate such averages. Older transactions would be decayed by time, and the average of the recent transactions is weighted more heavily. When combined with fraud aspects, behavior of a particular card number can be analyzed as a velocity to more easily calculate a statistical value for a parameter (e.g., such as time), by only analyzing and storing the more recent transactions. By calculating the statistical value for different parameters, these statistical values can be stored within the system and assist with removing older transactions, so that the stored history does not have to include the older transactions, thus, saving on computer memory space and other resources. While the above explanation uses transactions for a payment network, one having skill in the art would understand that the steps described herein may be used for any system where velocities need to be calculated for significant amounts of data over significant periods of time.

As described herein, a more efficient way to compute decay velocities for massive datasets comprising hundred-billions of transactions presents a formidable challenge. The exponential nature of decay calculations, as depicted in the formula below (Equation 1), necessitates sequential processing with a dependency to the last transaction velocity:

$${v}_{n} = {x}_{n} + {v}_{n - 1} {e}^{- α ( {t}_{n} - {t}_{n - 1} )} n = 0 … N \qquad ( Eq . 1 )$$

In Equation 1 shown above, νₙ represents the velocity at transaction n, xₙ is the metrics value of transaction n, α is the decay rate, and tₙ signifies a timestamp. Equation 1 can be used in an effective manner to process large datasets sequentially, and calculating velocities with Equation 1 may include the following procedures: (1) group the transaction data by the dimension key; (2) count the number of transactions in each group; (3) sort the transactions within each group (dimension key); (4) depending on the number of dimension keys and distributed computing partition size, divide transactions in each group into chunks and steps; (5) identify the last transaction in each chunk to detect the end of chunk timestamp; (6) repartition the data by chunk identifications (IDs); (7) within each partition, decay transaction values to the chunk's end timestamp and calculate the end of chunk decay velocity per dimensions available in the partition; (8) group by dimension key and chunk ID to collect all the end of chunks decay velocities; (9) shift chunk IDs such that each chunk can access the end of chunk velocity of prior chunk; (10) repartition the entire dataset by dimension key and chunk ID; (11) sort within the partition(s); and (12) computing the velocity/velocities.

However, use of Equation 1 is quite time-consuming and not particularly efficient, especially when the data volume exceeds the capacity of a single machine, prompting the utilization of distributed computing systems. Even if distributed computing systems are used, the intrinsic sequential constraints of Equation 1 may hold back a more efficient parallel method for velocity computation, and the requirement to calculate velocities for each dimension may further complicate the process, necessitating additional shuffling and grouping operations along with the requirement for large amounts of storage memory.

In this regard, one embodiment described herein includes the usefulness of Equation 1 in decay velocity applications. However, recognizing the computational overhead associated with sorting, partitioning, grouping, and aggregating operations, the present system and method provides another embodiment that is a reconfiguration of Equation 1 and includes a corresponding algorithm that minimizes the frequency of such resource-intensive actions, where this algorithm efficiently computes decay velocity based on two core aspects: (1) reducing the number of required groups, by shuffling and partitioning with an optimal partitioning, and (2) relaxing (e.g., reducing) the sequential dependency in calculating the decay velocities.

Optimal partitioning includes determining the ideal number of partitions based on the total transaction count and the temporal range of timestamps within a dataset, and then by leveraging the computational efficiency of map operations, assigning a suggested identification (ID) such as a partition ID (also referred to herein as a “ChronoID”) to each transaction using a straightforward equation that incorporates the target number of partitions, the dataset's temporal range, and each transaction's timestamp. Subsequently, the data is partitioned based on the range of these assigned IDs (e.g., ChronoIDs). This approach offers two distinct advantages: (1) it ensures automatic sorting, obviating the need for additional sorting algorithms; and (2) by guaranteeing temporal order between each partition, it simplifies subsequent processing steps by ensuring that each partition contains transactions chronologically equal to or preceding those in the preceding partition(s). Optimal partitioning may include manual assignment of suggested (e.g., recommended) partition IDs (e.g., ChronoIDs) to transaction data based on optimal partition count and timestamp of transactions through mapping (without any requirements of data shuffling).

Regarding sequential dependency reduction, by reconfiguring Equation 1, an alternative and improved formula for calculating decay velocity that relies on the cumulative sum of prior decay transaction values is derived. This reconfiguration significantly diminishes the reliance on immediate sequential calculations, which is beneficial for distributed computing and map-reduce algorithms, and leads to the following formula (Equation 2):

$${v}_{n} = \frac{{\sum }_{i = 0}^{n} {e}^{- α ( T - {t}_{i} ) + log ( {x}_{i} )}}{{e}^{- α ( T - {t}_{n} )}} \qquad ( Eq . 2 )$$

In Equation 2, νₙ represents the velocity at transaction n, xᵢ is the metrics value of transaction i, α is the decay rate, tₙ and tᵢ signify timestamps at transactions n and i, respectively, and T is an arbitrary timestamp that should be considered constant for all transactions (for simplicity, T can be considered as the maximum or minimum timestamp of the dataset). Since Tis an arbitrary and universal time for all transactions and dimension keys, Equation 2 allows for aggregation of transactions preceding the current timestamp freely. Consequently, unlike conducting velocity procedures using Equation 1, there is no need for grouping of common dimension keys (e.g., in a single partition), chunk creation, or calculation of chunk end times, streamlining the computational process considerably.

Furthermore, to practically make the algorithm based on Equation 2 more efficient and stable, the numerator of Equation 2 is kept until the very end of the calculation and then divided by the denominator. Hence, instead of calculating the value of exponential in the numerator and summing them, only the powers may be kept and summed accordingly such that:

$$if {e}^{a} + {e}^{b} = {e}^{c} then c = a + log ( 1 + {e}^{( b - a )} ) \qquad ( Eq . 3 )$$

By way of reconfiguring Equation 1 to derive Equations 2 and 3, the decay velocity algorithm based on Equation 2 (and Equation 3) described herein includes the steps of: (1) assigning a ChronoID to each transaction through mapping, then partitioning the dataset based on the range of assigned ChronoIDs; (2) through mapping within a partition, calculating the sum of available dimensions in each partition, then grouping the dimension key to shift the accumulated sum of dimensions to neighboring partitions; and (3) sorting within a partition(s) and computing the velocity. This provides a streamlined approach to calculating decay velocities without the need for complex data manipulation steps (e.g., eliminates immediate sequential dependencies, enabling a streamlined computational process without the need for strict ordering, tracking, or chunk calculations).

For each example embodiment, transactions may be sorted into different categories, including card (account) number, bank name/number, merchant number, bank range of credit card numbers, BIN numbers, etc., that is, any category where it is desired to calculate the velocity. This then becomes a key for the velocity. The key of the velocity may be a region, or the part of the traffic where calculation of the velocity is desired. For example, it may be desired to calculate the velocity for the card numbers, or for the banks (e.g., Bank 1 . . . . Bank N). In the case of the banks, if it is desired to evaluate the historical number of transactions for Bank 1, the key would be Bank 1. Or, if it is desired to evaluate a smaller dataset (e.g., to only see or calculate the historical transactions for each card number), the card number would be the key. A key is also referred to as a dimension key, and vice versa. Other non-limiting examples of keys include merchants, issuers, etc.

Machine learning (ML) is a subset within the more general artificial intelligence (AI) field. ML/AI may be used in conjunction with the decay velocity techniques described herein. ML involves the development and study of statistical algorithms that can be used to effectively perform tasks without explicit instructions on how to do it. For example, a machine learning model may be trained using historical data that enables the model to recognize patterns within the data and outputs resulting from those patterns. Thus, when the model is trained and applied to new data that is inputted into the model, the model is able to recognize those same patterns and predict an output based on the outputs from the historical data. Of course, in order to build and train the models that are subsequently used in the machine learning tools, it is beneficial to have quality data that is properly labeled and accurately represents the information that is desired to be learned about (although unlabeled data may also be used). The use of quality data having accurate labeling helps to ensure that the models that are trained and built will be able to accurately predict outcomes when applied to new data. ML has been applied and used in many areas and industry segments, including but not limited to large language models (LLMs), computer vision, speech recognition, email filtering, agriculture, medicine, insurance, and the financial or payment industry. In the payment industry, and as described herein, ML may be used in connection with determining patterns and/or gleaning other pertinent information relating to transactions, including the determining of fraud patterns, dimensions, velocities, etc.

Beyond detecting and preventing fraud, a velocity engine based on the present disclosure may also provide benefits in the management and optimization of other high volume data applications, such as rewards programs of credit cards or of other entities (e.g., rewards programs of retailers). The systems and methods described herein may improve the tracking of spending patterns and accumulation of reward points, ensuring that cardholders/customers receive the appropriate benefits and incentives based on the usage of their rewards account(s). This is just one additional example application out of many in which the systems and methods described herein can provide benefit to.

At least one technical effect of the systems and methods described herein is achieved by performing at least one of the following steps: (a) deriving an efficient and improved algorithm capable of processing velocities at an accelerated pace; (b) conducting processing of high volumes of data without the need for additional computer resources such as additional computer processing and/or memory resources (e.g., ability to use existing resources); (c) leveraging decay velocities across all the authentication and authorization fraud detection models and decision-making process; (d) conserving significant amounts of human and computational resources; (e) improving speed in the analysis of transaction data; (f) reducing network traffic when using distributed processing resources; (g) reducing processing required for determining velocity profiles for use in machine learning models; and (h) ability to analyze a wide variety of parameters and dimensions. More generally, a technical effect of the systems and methods described herein is improvements in distributed computing and parallel computations within distributed computing systems. The methods and systems described herein may be implemented using computer programming or engineering techniques including computer software, firmware, hardware or any combination or subset thereof.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, smartphones, personal digital assistants (PDAs), key fobs, and/or computers, without limitation. Each type of transactions card can be used as a method of payment for performing a transaction.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, “machine learning” (also referred to as ML) refers to statistical techniques to give computer systems the ability to “learn” (e.g., progressively improve performance on a specific task) with data, without being explicitly programmed for that specific task. The terms “neural network” (NN) and “artificial neural network” (ANN), used interchangeably herein, refer to a type of machine learning in which a network of nodes and edges is constructed that can be used to predict a set of outputs given a set of inputs.

In one embodiment, a computer program is provided, and the program is embodied on a computer readable medium. In an exemplary embodiment, the system is executed on a single computer system, without requiring a connection to a sever computer. In a further exemplary embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of AT&T located in New York, New York). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the disclosure by way of example and not by way of limitation. It is contemplated that the disclosure has general application to processing financial transaction data by a third party in industrial, commercial, and residential applications.

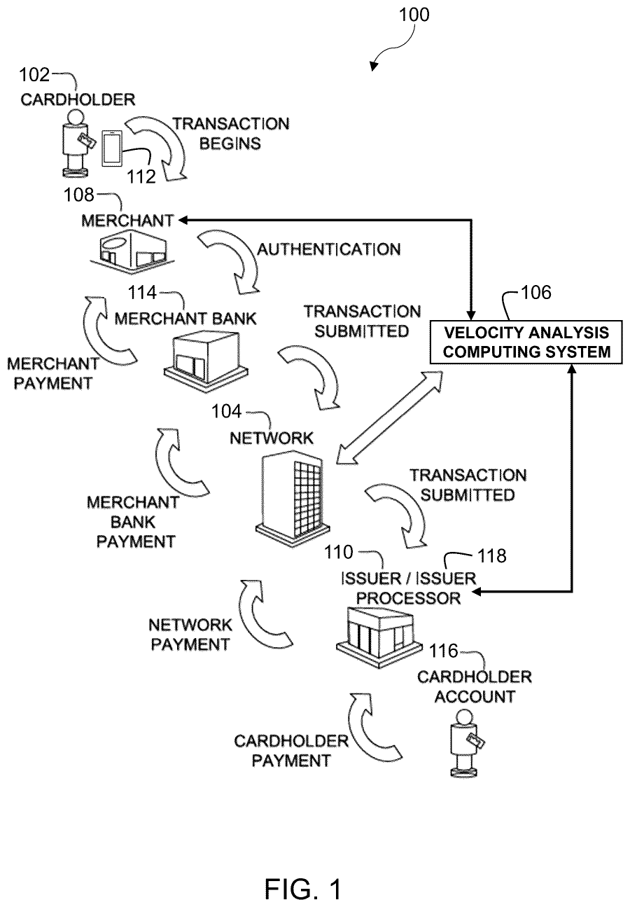

FIG. 1 illustrates a schematic diagram of an example multi-party payment account system 100 for enabling payment transactions initiated by cardholders 102 (e.g., purchasers 102) over a payment processing network 104 that is in communication and used in conjunction with a velocity analysis computing system 106. As described below in more detail, velocity analysis computing system 106 is configured to collect data from a merchant 108 (e.g., transaction data, operations data) or an issuer 110 and calculate delay velocity in connection with transactions. Embodiments described herein may relate to a transaction card system, such as a payment card payment system using the Mastercard interchange network and/or third party payment processing systems and networks. The Mastercard interchange network is a set of proprietary communications standards promulgated by Mastercard International Incorporated for the exchange of financial transaction data and the settlement of funds between financial institutions that are members of Mastercard International Incorporated. (Mastercard is a registered trademark of Mastercard International Incorporated located in Purchase, N.Y.). In the exemplary embodiment, velocity analysis computing system 106 is communicatively coupled to merchant 108, processing network 104, and issuer 110 (e.g., issuer bank). As used herein, merchant 108 and issuer 110 may be directly coupled to velocity analysis computing system 106, or may be indirectly coupled to velocity analysis computing system 106 through payment processing network 104.

In the example embodiment, a financial institution called the “issuer” or “issuing bank” issues an account, such as a credit card account, a debit account, or a prepaid card account to a cardholder 102, who uses the account to tender payment for a purchase from a merchant 108. In one embodiment, cardholder 102 presents a payment card and/or a digital wallet to merchant 108 using a user computing device (also known as card-present transactions). In another embodiment, the user does not present a physical payment device, and instead performs a card-not-present transaction. For example, the card-not-present transaction may be initiated via a digital wallet application, through a website or web portal, via telephone, or any other method that does not require the user to present a physical payment card to merchant 108 (e.g., via swiping or inserting the payment card and/or scanning the digital wallet).

To accept payment with the transaction card, merchant 108 establishes an account with a financial institution that is part of the financial payment system. This financial institution is usually called the “merchant bank,” the “acquiring bank,” or the “acquirer.” In one embodiment, cardholder 102 tenders payment for a purchase using a transaction card at a transaction processing device 112 (e.g., transaction device 112, e.g., a point of sale device in an in-store context, or a mobile computing device (e.g., mobile phone) or desktop/laptop computer in an at-home (e.g., online shopping) context), then merchant 108 requests authorization from a merchant bank 114 for the amount of the purchase. The request is usually performed through the use of a point-of-sale terminal or a computing device or computer app, which reads account information of cardholder 102 from a magnetic stripe, a chip, barcode, or embossed characters on the transaction card (e.g., a debit card or a prepaid card) or otherwise imputed by the cardholder and communicates electronically with the transaction processing computers of a merchant bank 114. Alternatively, merchant bank 114 may authorize a third party to perform transaction processing on its behalf. In this case, the point-of-sale terminal will be configured to communicate with the third party. Such a third party is usually called a “merchant processor,” an “acquiring processor,” or a “third party processor.”

In the example embodiment, merchant 108 communicates with, either directly or indirectly via processing network 104, other systems within multi-party payment account system 100 to authenticate cardholder 102 before the transaction is further processed or to assist an authentication device that is part of the multi-party payment account system shown in FIG. 1 in authenticating cardholder 102. For example, the same entity that provides velocity analysis computing system 106 may provide systems that can authenticate cardholder 102 as described herein. Once cardholder 102 has been authenticated, using processing network 104, computers of merchant bank 114 or merchant processor will communicate with computers of an issuer bank 110 to determine whether an account 116 of cardholder 102 is in good standing and whether the purchase is covered by an available credit line of cardholder 102. Based on these determinations, the request for authorization will be declined or accepted. If the request is accepted, an authorization code (e.g., included in an authorization message) is issued to merchant 108. An authorization message includes a transaction identifier associated with the transaction and an indicator indicating that the transaction was authorized. If the request is not accepted, authorization message includes a transaction identifier associated with the transaction and an indicator indicating that the transaction was declined. In the example embodiment, authorization message is formatted according to ISO 8583 network messaging protocol or the equivalent messaging protocol used by the payment card processing network.

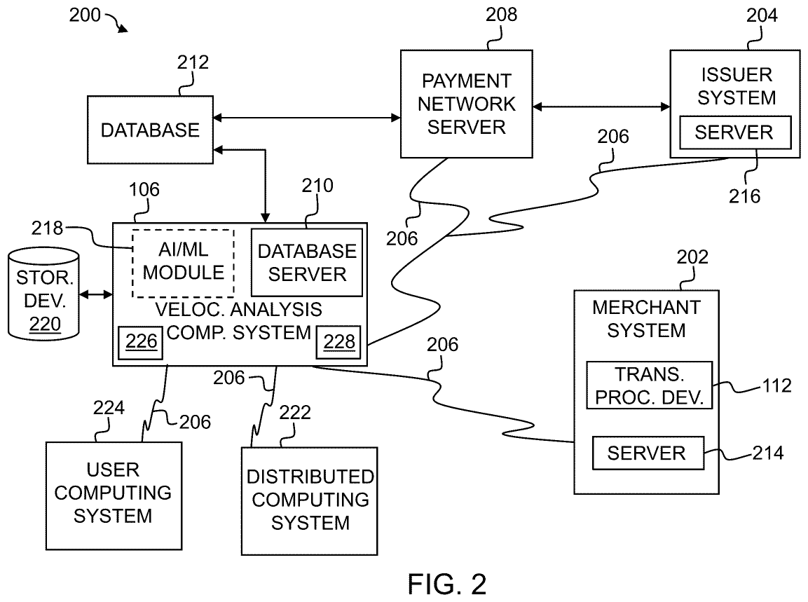

When a request for authorization is accepted, the available credit line of account 116 of cardholder 102 is decreased. Normally, a charge for a payment card transaction is not posted immediately to account 116 of cardholder 102 because certain rules do not allow merchant 108 to charge, or “capture,” a transaction until goods are shipped or services are delivered. However, with respect to at least some debit card transactions, a charge may be posted at the time of the transaction. When merchant 108 ships or delivers the goods or services, merchant 108 captures the transaction by, for example, appropriate data entry procedures on the point-of-sale terminal. This may include bundling of approved transactions daily for standard retail purchases. If cardholder 102 cancels a transaction before it is captured, a “void” is generated. If cardholder 102 returns goods after the transaction has been captured, a “credit” is generated. Processing network 104 and/or issuer bank 110 stores the transaction card information, such as a type of merchant, amount of purchase, date of purchase, etc. in a database (e.g., database 212, shown in FIG. 2).

After a purchase has been made, a clearing process occurs to transfer additional transaction data related to the purchase among the parties to the transaction, such as merchant bank 114, processing network 104, and issuer bank 110. More specifically, during and/or after the clearing process, additional data included in a clearing message, such as a time of purchase, a merchant name, a type of merchant, purchase information, user account information, a type of transaction, a transaction identifier, information regarding the purchased item(s) (e.g., product identifiers), information regarding container(s) of the purchased item(s) (e.g., container identifiers), and/or other suitable information, is associated with a transaction and transmitted between parties to the transaction as transaction data, and may be stored by any of the parties to the transaction. In the example embodiment, the clearing message is formatted according to ISO 8583 network messaging protocol or the equivalent messaging protocol used by the payment card processing network.

After a transaction is authorized and cleared, the transaction is settled among merchant 108, merchant bank 114, and issuer bank 110. Settlement refers to the transfer of financial data or funds among account of merchant 108, merchant bank 114, and issuer bank 110 related to the transaction. Usually, transactions are captured and accumulated into a “batch,” which is settled as a group. More specifically, a transaction is typically settled between issuer bank 110 and processing network 104, and then between processing network 104 and merchant bank 114, and then between merchant bank 114 and merchant 108.

As described above, the various parties to the payment card transaction include one or more of the parties shown in FIG. 1 such as, for example, cardholder 102, merchant 108, merchant bank 114, processing network 104 (also referred to herein as interchange 104 or interchange network 104), issuer bank 110, and/or an issuer processor 118. A transaction may be referred to in a temporal manner, such a historical (e.g., past or prior) transactions, current, or live (e.g., a transaction that may be occurring at any given live moment).

FIG. 2 illustrates a schematic diagram of an example velocity analysis computing platform 200 including velocity analysis computing system 106 and a plurality of client sub-systems coupled to the velocity analysis computing system 106, usable within or in communication with multi-party payment account system 100. Client sub-systems may include merchant system 202 (also referred to as merchant computing device 202, or more generally client sub-system 202) and issuer system 204 (also referred to as issuer computing device 204, or more generally client sub-system 204).

Client sub-systems 202 and 204 are coupled to the Internet through many interfaces including a network 206, such as a local area network (LAN) or a wide area network (WAN), dial-in-connections, cable modems, special high-speed Integrated Services Digital Network (ISDN) lines, and RDT networks. Merchant system 202 includes systems associated with merchants 108 (shown in FIG. 1) as well as external systems used to store data. For example, merchant system 202 may include transaction processing device 112 (shown in FIG. 1), which may be realized as a point-of-sale (POS) computing device (also referred to as POS terminal) communicatively and operatively coupled to an external system of merchants 108, or a website used by the merchant to sell goods or services. Issuer system 204 includes systems associated with issuer banks 110 (shown in FIG. 1) as well as external systems used to store data. Velocity analysis computing system 106 is also in communication with a payment network server 208 associated with interchange network 104 (shown in FIG. 1) using network 206. Further, client sub-systems 202 and 204 may additionally communicate with interchange 104 using network 206. In more general terms, client sub-systems 202 and 204 could be any device capable of interconnecting to the Internet including a web-based (e.g., mobile) phone, PDA, smart devices, or any other web-based connectable equipment such as a POS terminal (e.g., an embodiment of transaction processing device 112 (shown in FIG. 1)).

A database server 210 of velocity analysis computing system 106 is coupled to a database 212, which contains information and data on a variety of matters. For example, database 212 may store cardholder transaction data and issuer/merchant rules regarding transactions. Cardholder transaction data may be processed, sorted, and/or otherwise analyzed according to a list of defined parameters (e.g., transaction type, transaction time, device on which the transaction was initiated, dollar amount of transaction, market segment of merchant and/or item purchased, payment network parameters, and any other applicable parameter relating to ways to categorize such transactions) and rules. In one embodiment, database 212 is a centralized database stored on velocity analysis computing system 106, where access to centralized database 212 may be controlled by rules defined within platform 200 to limit the display of data to authorized client users enrolled with platform 200. In an alternative embodiment, database 212 is stored remotely from velocity analysis computing system 106 and may be non-centralized. Database 212 may be a database configured to store information used by velocity analysis computing system 106 including, for example, historical and current transaction data, prompt data, other user data, merchant data, issuer data, and/or other applicable data. Database 212 may include a single database having separated sections or partitions, or may include multiple databases, each being separate from each other. In some embodiments, database 212 stores transaction data generated over the processing network including data relating to merchants, consumers, account holders, prospective customers, issuers, acquirers, and/or purchases made. Database 212 may include multiple storage units such as hard disks or solid state disks in a redundant array of inexpensive disks (RAID) configuration, and may include a storage area network (SAN) and/or a network attached storage (NAS) system.

Additional components within platform 200 may include a server 214 of merchant system 202, a server 216 of issuer system 204, an artificial intelligence/machine learning (AI/ML) module 218 of velocity analysis computing system 106 (described in more detail herein), a storage device 220, a distributed computing system 222 (also referred to as distributed computing device 222 or more generally as a client sub-system 222), and a user computing system 224 (also referred to as a user computing device 224). Server 214 may be configured to provide access to resources, data, services, or programs to other computers of merchants 108 over network 206. Server 216 may be configured to provide access to resources, data, services, or programs to other computers of issuers 110 over network 206. AI/ML module 218 may be configured to assist with providing insight into transactions and/or velocity calculations performed by velocity analysis computing system 106 by learning transaction and calculation patterns over time via a model. Storage device 220 may include one or more storage devices used in conjunction with velocity analysis computing system 106, and may store therein both historical (e.g., training) data for training a model of AI/ML module 218, as well as newer transaction data and other data and information used to update velocity calculation algorithms and/or algorithms of AI/ML module 218, for use in association with the analysis performed by velocity analysis computing system 106.

In one embodiment, storage device 220 may be integrated with velocity analysis computing system 106. In other embodiments, storage device 220 may be integrated with database 212, or any other storage or database within platform 200. The model of AI/ML module 218 may be trained on transaction and/or velocity data to be able to better recognize and categorize new transactions, determine new or updated velocities, and/or assist with velocity calculations and procedures such as sorting, grouping, partitioning, etc. While AI/ML module 218 is shown in FIG. 2 as being integrated within velocity analysis computing system 106, it may also be separate from (but still operatively coupled to) velocity analysis computing system 106. Distributed computing system 222 may include a computing system separate from but operatively coupled to velocity analysis computing system 106 to provide parallel processing capabilities in association with velocity analysis computing system 106, to assist in handling high intensity processing tasks such as calculating velocities. In one embodiment, one or more distributed computing systems 222 may be able to access database 212 via network 206 as part of platform 200. One or more distributed computing systems 222 may be employed in a cloud computing environment to provide scalable and efficient computing resources when used in conjunction with the other computing devices/systems shown in FIG. 2. User computing system 224 may include a computing system separate from but operatively coupled to velocity analysis computing system 106 for a user that has been granted access to all or part of aspects of platform 200 to view and analyze results that are output from velocity analysis computing system 106, described herein in more detail.

Further regarding distributed computing system 222, the embodiments described herein leverage parallel processing to efficiently calculate velocity profiles for analysis of transaction data. Systems 22 may also be used in connection with the training of machine learning models of AI/ML module 218 to determine patterns of behavior. The machine learning models may use the patterns to detect anomalous activity in real-time, for example for use in transaction analysis and fraud detection. A processor or a processing element may be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs. Additionally or alternatively, the machine learning programs may be trained by inputting sample data sets or certain data into the programs, such as transaction data, network messages (e.g., ISO 8583 messages), and/or other internal data regarding transactions. The machine learning programs may utilize deep learning algorithms that may be primarily focused on pattern recognition and may be trained after processing multiple examples. The machine learning programs may include Bayesian program learning (BPL), voice recognition and synthesis, image or object recognition, optical character recognition, and/or natural language processing-either individually or in combination, for use, for example, in generating outputs for human consumption. The machine learning programs may also include natural language processing, semantic analysis, automatic reasoning, and/or (supervised) machine learning. In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs.

There may be two primary systems for handling transactions: (1) a live system 226 (also referred to as live transaction system 226) which tags and detects each transaction when it comes through the payment network 104; and (2) an offline system 228 which is primarily used for analysis of the transactions. In the live transaction system 226, if, for example, a decay parameter is 7 days decayed, this means that only 7 days of historical transaction data are needed for that specific parameter. In the case of a year's worth of historical transaction data for a card/account number, the data would be decayed to just 7 days before the current day and just that number would be kept for historical transaction data purposes for that particular transaction or account. In other words, instead of analyzing data for the full year, just a single parameter (e.g., 7-day decay velocity) is analyzed for that time period and for that account. That is, just 7 days of transactions can be sufficiently informative as to calculate decay velocity for historic card transactions for a particular card number. In this manner, larger periods of time (e.g., one year) and accumulated data (e.g., one year's worth of data) can be accurately approximated (e.g., the decay velocity can be calculated with a large, accumulated decay value.

The offline system 228 may function as a testbed environment to determine which decay rates and/or which velocities are needed and then evaluate machine learning models (e.g., perception layers) of AI/ML module 218, where there may be one or more models focused on decay rates, velocities, etc. As such, the offline system 228 may serve as an exploration and evaluation tool. Because certain variables may be unknown, the analysis in the offline system 228 may provide a better sense of if there is a need to decay other parameters of transactions in a specified manner. Transaction data typically varies based on the type of account. For example, compared to a personal payment card, a corporate payment card may initiate a fewer number of transactions over time, but the average U.S. dollar spend on a corporate account may be greater than the personal account. Additionally, a corporate payment card account may, on average, be paid off on a month-to-month basis, whereas a personal payment card account may, on average, be paid off on a week-to-week basis or may not fully be paid off each month. As such, a distant cyclic behavior depends on the order, or channel (e.g., corporate vs. consumer/personal) being used. The offline system 228 may evaluate what decay rate would be necessary or required for a specific channel.

Live system 226 and/or offline system 228 may be integrated with velocity analysis computing system 106, or may be provided separate from but operatively and communicatively coupled to velocity analysis computing system 106 within platform 200. For example, live system 226 and/or offline system 228 may be realized on one or more of distributed computing systems 222. AI/ML module 218 may be integrated with velocity analysis computing system 106 or alternatively or additionally in one or more of offline system 228 and/or one or more distributed computing systems 222.

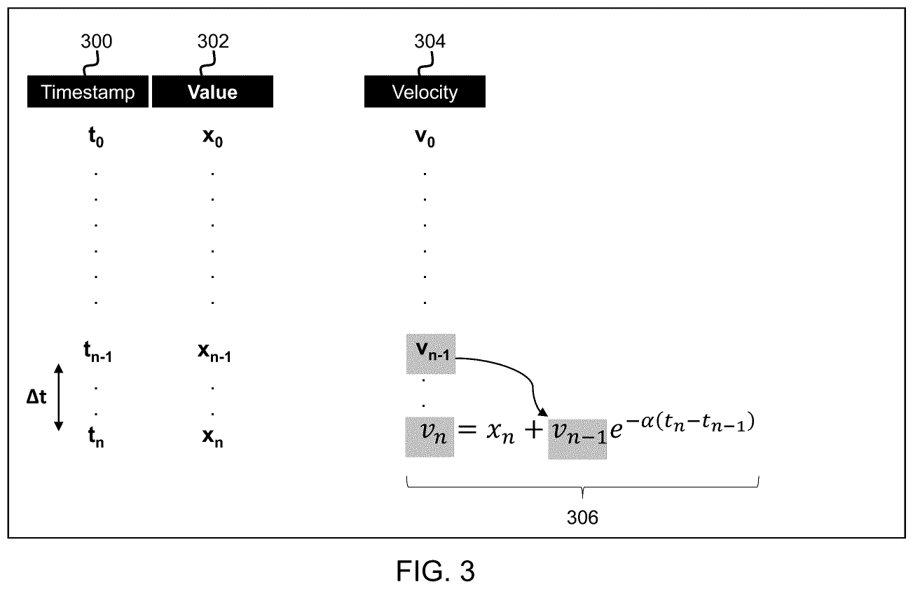

FIG. 3 illustrates a first embodiment for a velocity engine that includes a decay velocity algorithm (e.g., using Equation 1) used therein and calculation of velocities performed by such. A plurality of timestamps 300 ranging, for example, from t₀ to tₙ₋₁ to tₙ exist, and provide for the calculation of a Δt quantity (e.g., a time difference between any particular transaction timestamps within the time series (e.g., the set of timestamps)). A plurality of values 302 ranging, for example, from x₀ to xₙ₋₁ to xₙ exist, and correspond to timestamps t₀ to tₙ₋₁ to tₙ of the plurality of timestamps 300. Any one value of values 302 may be representative of a particular target velocity, such as a target velocity for a specified transaction parameter. A plurality of velocities 304 ranging, for example, from v₀ to vₙ₋₁ to vₙ exist, and correspond to timestamps t₀ to tₙ₋₁ to tₙ of the plurality of timestamps 300 and x₀ to xₙ₋₁ to xₙ of the plurality of values 302. For example, in one scenario value x may be a targeted velocity, such as a velocity relating to a U.S. dollar amount of a transaction as in the above discussed example. When it is desired to calculate this velocity for the time series of time and for the amount, the velocities at each transaction, for example transaction n, would be the value of the card transaction, which is for example a U.S. dollar amount for a current transaction, and then velocity of the previous transaction multiplied by a decay (e.g., exponential decay). This is represented by equation 306 (e.g., Equation (1)). The time difference between the current transaction and the exact last transaction before it is represented by the Δt quantity, which may be in a desired time measurement unit, such as seconds, minutes, days, etc., depending on the decay rate (e.g., the time measurement unit of the decay rate). Thus, calculations would be performed in the defined time measurement unit (seconds, days, etc.), where a decay rate in seconds, for example, is calculated in seconds, and any necessary conversions are performed to convert any recorded transactions into the desired time measurement unit.

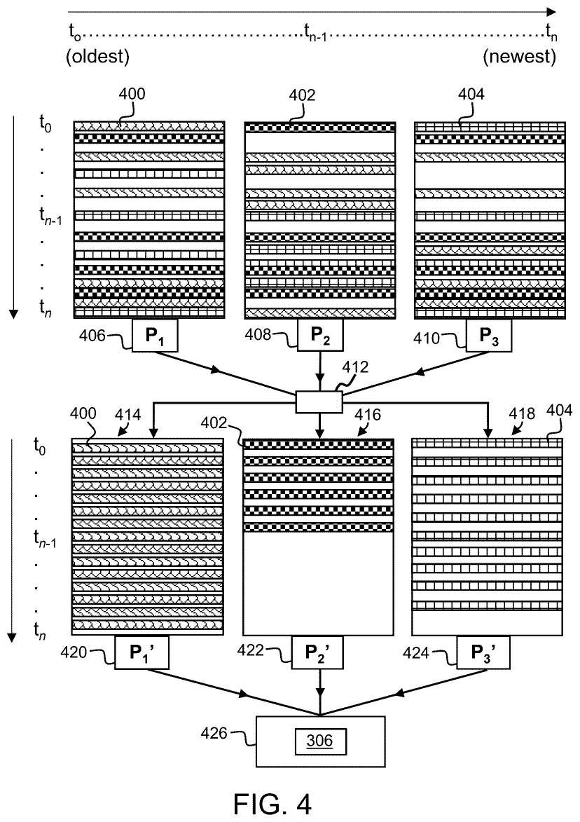

FIG. 4 illustrates partitioning of data, such as transaction data, in accordance with the velocity engine embodiment represented by FIG. 3, where incoming data is divided into partitions. The incoming data is depicted in FIG. 4 as different data 400, 402, and 404 within partitions 406, 408, 410 (where partition 406 is also referred to as P₁, partition 408 is also referred to as P₂, and partition 410 is also referred to as P₃). The respective patterns of the boxes representing data 400, 402, 404 shown in FIG. 4 may be representative of (e.g., different) dimension keys. The volume of data is very large and as such cannot practically be stored in a single storage (e.g., single computer or single node), and so the data is divided into and kept in different partitions (where the partitions may be present on various storage devices within platform 200, such as storage device 220, or within storage devices of one or more distributed computing systems 222). Each type of data 400, 402, 404 represents one key, which may represent a certain common type of velocity data. For example, the data may include velocity data of a particular cardholder (e.g., of a particular card number of a particular cardholder).

In such a scenario, data 400, 402, and 404 may be representative of velocity data for three different card numbers of one cardholder, or three different card numbers of three different cardholders, or any other combination of such. For example, in each partition (P₁, P₂, P₃) the dimension key and the velocity may be the card number, where a first card number is represented by data 400, a second card number is represented by data 402, and a third card number is represented by data 404, and these various types of data may be separated into different nodes. To use equation 306 shown in FIG. 3, one must first group all of this card transaction data into their own respective partition(s) (e.g., group the transaction data by the dimension key by way of grouping module 412, which may perform one or more grouping processes, as reflected by grouping 414 in partition 420 (P₁′), grouping 416 in partition 422 (P₂′), and grouping 418 in partition 424 (P₃′) (where partitions P₁′, P₂′, and P₃′ may be partitions that are the same as or different from partitions 406 (P₁), 408 (P₂), and 410 (P₃)). This requires going to all of the nodes and selecting the transactions for a specific cardholder, and then grouping the transactions for the specific cardholder together, which enables calculation of the velocities for each separately mapped card number. Grouping module 412 may be configured as code (e.g., a software module) within velocity analysis computing system 106 or within other devices/systems (e.g., systems 222) of platform 200.

With respect to partitions 406, 408, and 410 shown in the upper half of FIG. 4, data within the partitions is chronological, with data in each partition 406 (P₁), partition 408 (P₂), and partition 410 (P₃) being stored in chronological order relative to one another (with partition 406 (P₁) representing the oldest data and partition 410 (P₃) representing the newest data). This is represented by the time scales shown in FIG. 4. The vertical time scale for each partition spans, from top to bottom, from timestamps t₀ . . . tₙ₋₁ . . . tₙ, with to being an initial time, tₙ being a last time, and tₙ₋₁ being an intermediate time between the initial time and the last time. The horizontal time scale spans, from left to right, from t₀ . . . tₙ₋₁ . . . tₙ (or oldest to newest). In other words, partition P₁ contains the oldest data from amongst all the data in partitions P₁, P₂, and P₃, partition P₃ contains the newest data from amongst all the data in partitions P₁ and P₂, and partition P₂ contains data newer than that in partition P₁ but older than that in partition P₃. More specifically, the first transaction in P₁ would be the oldest transaction between each of partitions P₁, P₂, and P₃, whereas the last transaction in P₃ would be the newest transaction between each of partitions P₁, P₂, and P₃. This also means that (i) the first transaction in P₁ would be the oldest transaction in P₁, (ii) the last transaction in P₁ would be the newest transaction in P₁, (iii) the first transaction in P₂ would be the oldest transaction in P₂, but newer than the last transaction in P₁, (iv) the last transaction in P₂ would be the oldest transaction in P₂, (v) the first transaction in P₃ would be the oldest transaction in P₃, but newer than the last transaction in P₂, and (vi) the last transaction in P₃ would be the newest transaction in P₃, and newer than any other transaction in each of P₁, P₂, and P₃.

With respect to partition groupings 414, 416, 418 in the lower half of FIG. 4, data within each grouping is sorted oldest to newest according to t₀ . . . tₙ₋₁ . . . tₙ. This means that (i) the first transaction in partition grouping 414 is the oldest transaction in partition grouping 414, (ii) the last transaction in partition grouping 414 is the newest transaction in partition grouping 414, (iii) the first transaction in partition grouping 416 is the oldest transaction in partition grouping 416, (iv) the last transaction in partition grouping 416 is the oldest transaction in partition grouping 416, (v) the first transaction in partition grouping 418 is the oldest transaction in partition grouping 418, and (vi) the last transaction in partition grouping 418 is the newest transaction in partition grouping 418. In other words, compared to how data is stored in partitions P₁, P₂, and P₃ before being grouped into partition groupings 414, 416, and 418, partition groupings 414, 416, and 418 do not encompass a shared chronology because the chronology is specific to each of data 400, 402, 404. After grouping, the data can be referenced and used by velocity calculation module 426 for performing calculations on the grouped data with equation 306, where velocity calculation module 426 may be configured as code (e.g., a software module) integrated within velocity analysis computing system 106 or within other devices/systems (e.g., system(s) 222) within platform 200. Additionally, AI/ML module 218 may trained on and learn about any of the data (e.g., data 400, 402, and 404, partitions, groupings, and other techniques shown and described in conjunction with FIG. 4 so that a corresponding model of AI/ML module 218 may implemented to learn about and improve data handling, partitioning, and other aspects within platform 200.

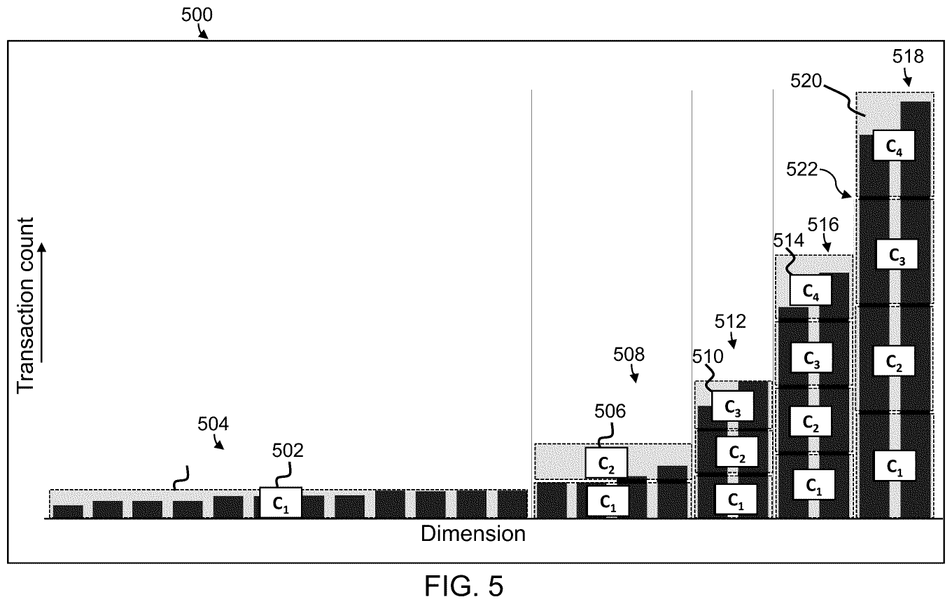

FIG. 5 illustrates example counting and grouping procedures in connection with the velocity engine embodiment of FIGS. 3 and 4. Graph 500 illustrates an example depiction of Transaction Count (y-axis) relative to a Dimension (x-axis). Graph 500 shows various count indicators (c₁, c₂, c₃, and c₄) for transactions and groups of the indicators. For example, graph 500 shows (i) count indicator 502 for one count (c₁) in group 504, (ii) count indicator 506 for two counts (c₂) in group 508 (as well as a c₁ count), (iii) count indicator 510 for three counts (c₃) in group 512 (as well as c₁ and c₂ counts), (iv) count indicator 514 for four counts (c₄) in group 516 (as well as c₁, c₂, and c₃ counts), and (v) group 518 including c₁, c₂, c₃, and c₄ counts. Any one block 520 may represent a chunk, and any transition between adjacent stacked blocks 520 may represent a step 522. The approach shown in FIG. 5 includes: (1) counting the number of transactions in each group; (2) sorting the transactions within each group (e.g., by dimension key); (3) depending on the number of dimension keys and framework partition size, dividing transactions in each group into chunks and steps; and (4) identifying the last transaction in each chunk to detect the end of chunk timestamp. AI/ML module 218 may trained on and learn about any of the counts, groups, chunks, and/or steps and other techniques shown and described in conjunction with FIG. 5 so that a model of AI/ML module 218 may implemented to improve counting, grouping, and other aspects.

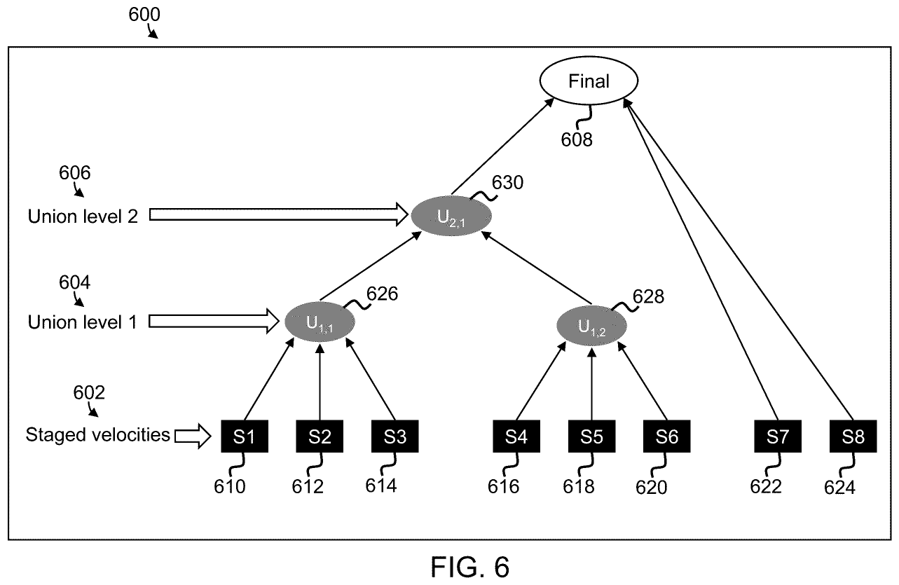

FIG. 6 illustrates chunk and partitioning procedures in connection with the velocity engine embodiment of FIGS. 3-5. Diagram 600 illustrates staged velocities 602, a first union level 604 (e.g., union level 1), a second union level 606 (e.g., union level 2), and a final level 608. The staged velocities may relate, for example, to monitoring the rate at which a certain event occurs, such as transactions occurring over a specific period, or another data event or information that is desired to be monitored, as described herein. Staged velocities 602 may include one or more staged velocities such as first staged velocity 610 (e.g., S1), second staged velocity 612 (e.g., S2), third staged velocity 614 (e.g., S3), fourth staged velocity 616 (e.g., S4), fifth staged velocity 618 (e.g., S5), sixth staged velocity 620 (e.g., S6), seventh staged velocity 622 (e.g., S7), and eight staged velocity 624 (e.g., S8). Chunking includes dividing the large dataset(s) of the velocities into smaller, manageable pieces of data called chunks. Each data chunk may be processed independently, which helps in parallel processing and reduces computational load. The data chunks may be assigned chunk IDs which can be shifted such that each chunk can access the end of a chunk velocity of a prior chunk. Partitioning may be used to divide the dataset into distinct subsets (e.g., partitions) based on certain criteria. Each partition may be mutually exclusive and collectively exhaustive, meaning that every data point belongs to one and only one partition. Partitioning may include repartitioning the entire dataset by dimension key and chunk ID. Then sorting within a respective partition(s) is performed, followed by computing the velocity.

Aggregation and/or other combinations of results from different chunks or partitions may take place in a union level. For velocity calculations, this may involve merging velocity vectors or other metrics from each chunk or partition. For example, for velocity calculations, this may include combining velocity data and/or information (e.g., velocity vectors) and/or other parameters/metrics from each chunk or partition to get an in-depth or more comprehensive view of the data set, or to update the velocity of the current chunk based on values from previous chunks. Union level 604 (e.g., union level 1) may include data from one or more subsets of staged velocities, such as a first subset 626 (e.g., U_{1.1}) of staged velocities and a second subset 628 (e.g., U_{1.2}) of staged velocities. The first subset 626 (e.g., U_{1.1}) of staged velocities may include staged velocities 610, 612, and 614. The second subset 628 (e.g., U_{1.2}) of staged velocities may include data from staged velocities 616, 618, and 620. In clustering, these concepts help in managing and analyzing large datasets by breaking them down into smaller, more manageable parts such as subsets 626 and 628 (also referred to as level 1 subsets), and to take advantage of parallel computing, where different chunks or partitions can be processed simultaneously, leading to faster and more efficient computations. Union level 606 (e.g., union level 2) may include data from one or more subsets such as subset 630 (e.g., U_{2.1}, also referred to as a level 2 subset), which may include data from one or more subsets such as first subset 626 (e.g., U_{1.1}) and second subset 628 (e.g., U_{1.2}).

Final synthesis and analyzation of the aggregated data may be performed at final level 608 to obtain a comprehensive understanding of the data, or to determine the final values of the combined velocities. This analysis may include (i) calculating overall metrics such as average velocity and/or other relevant statistics as described herein, (ii) visualization such as creating graphs and/or charts to visualize the combined data, and/or (iii) interpretation such as drawing conclusions or making decisions based on the aggregated results, which may be performed by or in conjunction with a machine learning model as described herein. Final level 608 may include data from one or more staged velocities such as seventh staged velocity 622 (e.g., S7) and eighth staged velocity 624 (e.g., S8), as well as from one or more subsets, such as subset 630 (e.g., U_{2,1}) from union level 606 (e.g., union level 2). AI/ML module 218 may trained on and learn about any of the velocities, levels, and other techniques shown and described in conjunction with FIG. 6 so that the model of AI/ML module 218 may implemented to improve chunk and partitioning and other aspects. However, the velocity engine embodiment represented by FIGS. 3-6 still needs to know the last value (e.g., xₙ shown in FIG. 3), cannot be mapped row-by-row; and cannot distribute rows of a group.

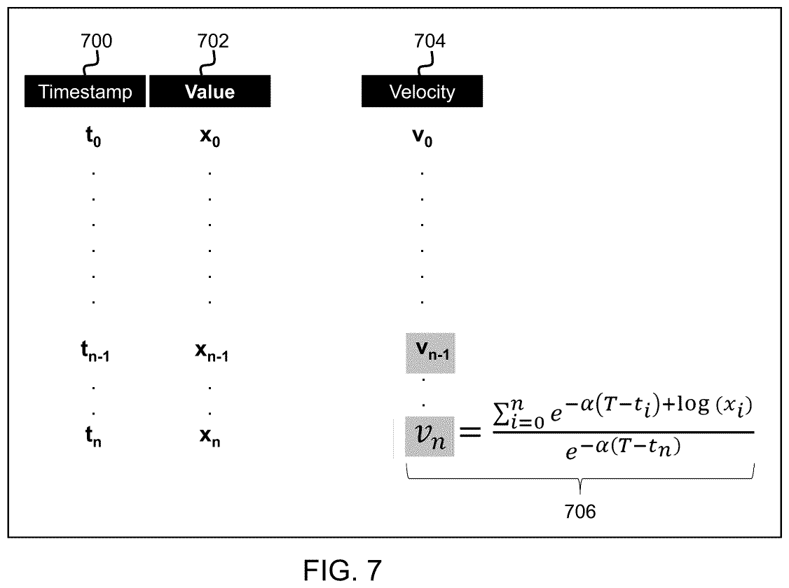

FIG. 7 illustrates a second (and preferred) embodiment for a velocity engine that includes a decay velocity algorithm (e.g., using Equation 2 as described herein) used therein and calculation of velocities performed by such. A plurality of timestamps 700 ranging, for example, from t₀ to tₙ₋₁ to tₙ exist. However, unlike as shown in FIG. 3, there is no need to calculate any Δt quantity for reasons explained herein. A plurality of values 702 ranging, for example, from x₀ to xₙ₋₁ to xₙ exist, and correspond to timestamps t₀ to tₙ₋₁ to tₙ of the plurality of timestamps 700. Any one value of values 702 may be representative of a particular target velocity, such as a target velocity for a specified transaction parameter. A plurality of velocities 704 ranging, for example, from v₀ to vₙ₋₁ to vₙ exist, and correspond to timestamps t₀ to tₙ₋₁ to tₙ of the plurality of timestamps 700 and x₀ to xₙ₋₁ to xₙ of the plurality of values 702. For example, in one scenario value x may be a targeted velocity, such as a velocity relating to a U.S. dollar amount of a transaction. When it is desired to calculate this velocity for the time series of time and for the amount, the velocities at each transaction, for example transaction n, would be the value of the card transaction, which is for example a U.S. dollar amount for current transaction, and then sum of the previous transaction(s) is utilized in connection with quantity T and exponential decay (e.g., a), as represented in equation 706. Calculations may be performed in a pre-defined time measurement unit, seconds, days, etc., where a decay rate in seconds is calculated in seconds, and any necessary conversions are performed to convert any recorded transactions into the desired time measurement unit.

As with the embodiment of FIG. 3, in the embodiment of FIG. 7, transactions may be sorted into different categories, including card or account number, bank name/number, merchant number, bank range of credit card numbers, BIN numbers, etc., that is, any category where it is desired to calculate the velocity. This then becomes a key for the velocity. The key of the velocity may be a region, or the part of the traffic where it is desired to calculate the velocity. For example, if may be desired to calculate the velocity for the card numbers, or for certain merchants (e.g., Merchant 1 . . . . Merchant N). If it is desired to see the historical number of transactions for Merchant 1, the key would be Merchant 1. Or, if it is desired to use a smaller dataset (for example to only see or calculate the historical transactions for each card number), the card number would be the key (also referred to as a dimension key, and vice versa).

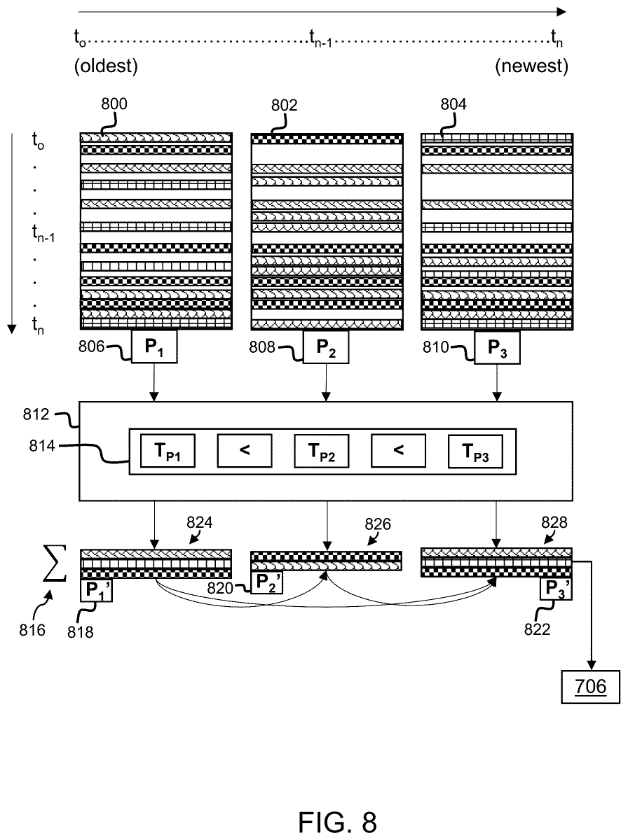

FIG. 8 illustrates a second (and preferred) embodiment for partitioning of data, such as transaction data, in accordance with the velocity engine embodiment represented by FIG. 7. The incoming data is depicted in FIG. 8 as data 800, 802, and 804 within partitions 806, 808, 810 (where partition 806 is also referred to as partition P₁, partition 808 is also referred to as partition P₂, and partition 810 is also referred to as partition P₃). Data 800, 802, and 804 may be the same as or similar to data 400, 402, and 404 in FIG. 4, respectively, except that the data 800, 802, 804 represent is processed according to equation 706 shown in FIG. 7 (instead of equation 306 shown in FIG. 3). The respective patterns of the boxes representing data 800, 802, 804 shown in FIG. 8 may be representative of (e.g., different) dimension keys. Similarly, partitions 806, 808, 810 may be the same as or similar to partitions 406, 408, 410 in FIG. 4, respectively, except that the partitions in FIG. 8 are populated according to the techniques of embodiment of FIG. 7 (instead of those of the embodiment shown in FIG. 4). The arrangement shown in each of partitions 806, 808, 810 may be representative of data 800, 802, and 804 being arranged based on assigned ChronoIDs, and more specifically a range of assigned ChronoIDs. As with FIG. 4, the volume of data in connection with FIG. 7 is very large and as such cannot practically be stored in a single storage (e.g., single computer or single node), and so the data is divided into and kept in different partitions (e.g., within storage devices of one of more distributed computing systems 222 and/or other storage devices of platform 200). Each data 800, 802, 804 represents one key, which may represent a certain common type of velocity data. For example, the data may include velocity data of a particular cardholder (e.g., of a particular card number of a particular cardholder).

In such a scenario, data 800, 802, and 804 may be representative of velocity data for three different card numbers of one cardholder, or three different card numbers of three different cardholders, or any other combination of such. For example, in each partition (P₁, P₂, P₃) the dimension key and the velocity may be the card number. A first card number may be data 800, a second card number may be data 802, and a third card number may be data 804. The data (e.g., 800, 802, 804) is operated on in grouping/sorting module 812, which includes one or more grouping/sorting processes in order to prepare the data for being calculated according to equation 706 for velocity calculations. To use equation 706 as shown in FIG. 7, it is not necessary to first group all of this card transaction data into their own respective partition (as is required in the embodiment of FIG. 4).

Data within each partition 806 (P₁), partition 808 (P₂), and partition 810 (P₃) is chronological, and each partition 806 (P₁), partition 808 (P₂), and partition 810 (P₃) is also in chronological order relative to one another (with partition 806 (P₁) representing the oldest data and partition 810 (P₃) representing the newest data). This is represented by the time scales shown in FIG. 8. The vertical time scale for each partition spans from, top to bottom, from timestamps t₀ . . . tₙ₋₁ . . . tₙ. The horizontal time scale spans, from left to right, from oldest to newest. In other words, partition P₁ contains the oldest data from amongst partitions P₁, P₂, and P₃, partition P₃ contains the newest data from amongst partitions P₁, P₂, and partition P₂ contains the data newer than partition P₁ but older than partition P₃. More specifically, the first transaction in P₁ would be the oldest transaction between each of partitions P₁, P₂, and P₃, whereas the last transaction in P₃ would be the newest transaction between each of partitions P₁, P₂, and P₃. This is represented by expression 814 in FIG. 8, where the “T” quantity for P₁ is less than the “T” quantity for P₂ which is less than the “T” quantity for P₃.

Compared to equation 306 and the embodiment shown in and described in connection with FIGS. 3-6 (where grouping of all of the transactions into their respective own partitions, and calculating the last timestamps (or the different timestamps) between transactions is performed), there is no ΔT (or Δt) quantity as there is no need to calculate the prior transaction before the current transactions. Grouping as shown in FIG. 4 via groupings 414, 416, 418 can be omitted because there is no need to calculate the last velocities (e.g., last velocity for a transaction) and then calculate the equation to determine the velocities for the recent transactions. Sums of the dimension keys are shown in partition 818 (P₁′), partition 820 (P₂′), and partition 822 (P₃′) (where partitions P₁′, P₂′, and P₃′ may be partitions that are the same as or different from partitions 806 (P₁), 808 (P₂), and 810 (P₃)). For example, partition 818 (P₁′), partition 820 (P₂′), and partition 822 (P₃′) may be defined as preceding partitions relative to partitions 806 (P₁), 808 (P₂), and 810 (P₃) (and/or relative to one another). In some embodiments, partition 818 (P₁′), partition 820 (P₂′), and partition 822 (P₃′) may be defined as neighboring partitions relative to partitions 806 (P₁), 808 (P₂), and 810 (P₃) (and/or relative to one another). Groupings 824, 826, 828 are representative of grouping the summed dimension keys stemming from the grouping/sorting processes executed by grouping/sorting module 812 on data 800, 802, 804 and summation 816 applied to grouped/sorted data 800, 802, 804 (e.g., after being processed via grouping/sorting module 812).

The contents of one or more of partition 818 (P₁′), partition 820 (P₂′), and/or partition 822 (P₃′) is/are then able to be processed via equation 706 for calculation of velocities, where, by way of the derivation of equation 706, all that needs to be known is some prior transactions, such as a transaction on the second partition (or node), to calculate velocities. This eliminates the need to sort and/or to group transaction together, representing a significant advantage and improvements in speed of processing transaction data and other benefits as described herein. Compared to strain on resources when using equation 306, realizing a computer-based implementation of the summation technique of equation 706 may exhibit more strain on computing hardware such as memory due to the need to find summations of previous partitions as expressed in equation 706. For example, processing a very large volume of transactions is a memory intensive procedure and puts pressure on the system as sums of transactions of a previous partition are pulled.

However, equation 706 calculates velocities faster than equation 306, and the increase in speed may be viewed as offsetting any potential negatives associated with any increase in resource strain (e.g., memory strain). The omission of the grouping module 412, a process which is very computationally costly (e.g., because of the need to go through all of the clusters and make a query and determine which transactions are in any particular cluster, and then propagate this data through the network, drafting them together and placing them all on one system) is also a benefit of the embodiment of FIGS. 7 and 8. Because there is no need for ΔT (or Δt), there is no need to group transactions (e.g., no need to group time stamped transaction for any particular card number). Equation 706 provides increased flexibility, for example by eliminating the need to group each transaction to its own partition(s) as shown in FIG. 4, as calculation of decay velocities can be performed “as is”. AI/ML module 218 may trained on and learn about any of the data, groups, and other techniques shown and described in conjunction with FIGS. 7 and 8 so that the model of AI/ML module 218 may implemented to improve decay velocity processes and other aspects.

In order to use either velocity equation(s) 306 or 706, it is necessary to operate for a group of keys. For example, in equation 706, the transactions are still present based on the particular card number. Because there is no need for ΔT (or Δt), there is no need to group the transaction together on a per card number basis, as velocities can be calculated in place (e.g., as they were originally populated within any one partition). The transactions in P₁ are summed and used to inform the next partition P₂, the transactions in P₂ are summed and used to inform the next (or neighboring) partition P₃, and so on and so forth (e.g., that information is to be transferred to the next, or the neighbor, partition). The transactions in P₁, P₂, and P₃ are chronological (e.g., P₁ contains the oldest transactions, and P₃ contains the newest transactions). The “T” quantity being arbitrary means that it is constant so every transaction has the same quantity for every card number. Thus, the “T” quantity represents the same time for every card number, making the “T” quantity arbitrary as it does not matter what the “T” quantity is so long as it is the same for every card number. This calculation can be utilized for any given dimension, e.g., BIN numbers, particular types of cards, etc. This means that whenever the key is defined, e.g., the specified key, the velocity equation is for that particular key. The efficient algorithm described herein in connection with equation 706 allows for aggregation of transactions preceding the current timestamp freely. As such, there is no need for dimension key grouping as shown in FIG. 4, chunk creation or calculation of chunk end times as shown in and described in connection with FIG. 5, and the computational process is streamlined considerably compared to other techniques and/or embodiments (notwithstanding that the embodiment of FIGS. 3-6 still has its own utility and benefit).

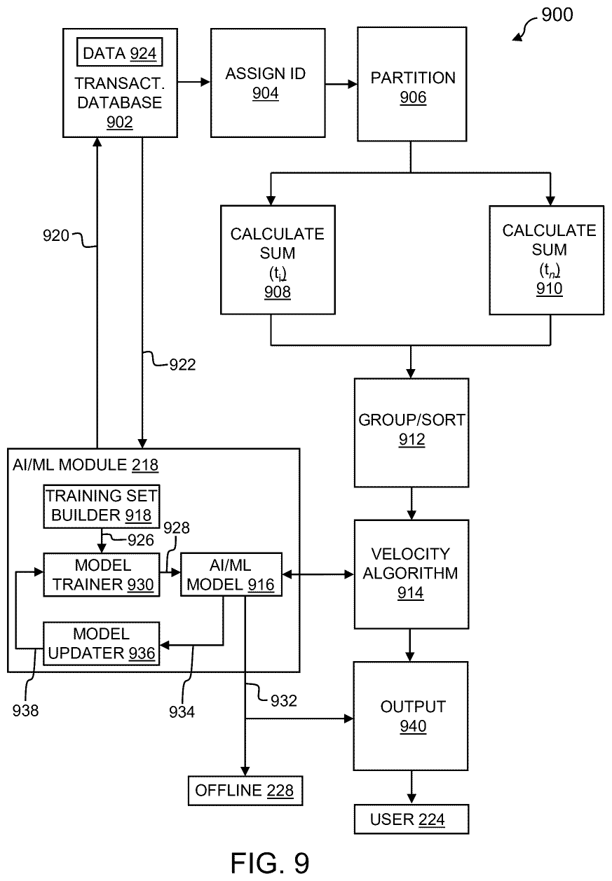

FIG. 9 illustrates a block diagram for an example data flow 900 for calculating and analyzing velocities, such as provided within platform 200 shown in FIG. 2 and in accordance with the velocity embodiment of FIGS. 7 and 8. Transaction data (e.g., data from transactions of a cardholder (e.g., cardholder 102)) from transaction database 902 is retrieved and assigned an ID (e.g., a ChronoID) by ID assignment module 904, which is configured to assign IDs through mapping to generate a dataset. Partition module 906 is configured to partition the dataset based, for example, on a range of assigned IDs. Calculation module 908 is configured to calculate aspects (e.g., sums) of available dimensions in each partition (e.g., relative to tᵢ). Calculation module 910 is configured to calculate aspects (e.g., sums) of available dimensions in each partition (e.g., relative to tₙ). For example, the calculations performed by calculation modules 908 and 910 may be performed via parallel processing provided by one or more distributed computing systems 222 operatively coupled to velocity analysis computing system 106. Grouping/sorting module 912 is configured to group dimension keys to shift accumulated sums of dimensions to neighboring partitions and sort within partitions (grouping/sorting module 912 may be the same as, similar to, or integrated with grouping/sorting module 812 shown in FIG. 8). Velocity algorithm module 914 is configured to apply the algorithm (including the velocity equation (e.g., Equation 2)) to compute velocities. Velocity algorithm module 914 may also be configured to implement or be integrated with AI/ML model 916 associated with AI/ML module 218 as described herein, where AI/ML model 916 may be trained on transaction and/or velocity data to recognize and learn certain characteristics of the transaction and/or velocity data for improved various aspects within platform 200, and in particular within velocity analysis computing system 106, such as assigning of IDs, sum calculations, grouping, sorting, and/or any other data handling/processing techniques. AI/ML model 916 may also assist with generating new velocities based on parameters of the model, and/or to perform other analysis or generate other insights into data within platform 200.

In exemplary embodiments, velocity analysis computing system 106 includes AI/ML module 218 for implementing AI/ML model 916, and AI/ML module 218 includes a training set builder module 918 configured to submit one or more queries 920 to a database such as transaction database 902 to retrieve subsets 922 of data 924 from transaction database 902, and to use those subsets 922 to build training data sets 926 for generating AI/ML model 916. For example, query 920 may be configured to retrieve certain fields from data 924 for historical claims sharing characteristics, transactions originated by certain POS or merchants, transaction history for a customer, and the like, as described herein in connection with dimensions and velocity calculations.

In exemplary embodiments, training set builder module 918 may be configured to derive training data sets 926 from retrieved subsets 922. Each training data set 926 may correspond to historical data from data 924 (“historical” in this context means completed in the past, as opposed to completed in real-time with respect to the time of retrieval by training set builder module 918). Each training data set 926 may include “model input” data fields along with at least one “result” data field representing a historical outcome associated with the model input. The model input data fields represent factors that may be expected to, or unexpectedly be found during model training to, have some correlation.

In exemplary embodiments, the model input data fields in training data sets 926 may be generated from data fields in subset 922 corresponding to (e.g., historical) data 924. In other words, a trained machine learning model 928 produced by a model trainer module 930 for use by AI/ML model 916 is trained to make predictions based on input values that can be generated from the data fields in data 924. Values in the model input data fields may include values copied directly from values in a corresponding data field in the retrieved subset 922, and/or values generated by modifying, combining, or otherwise operating upon values in one or more data fields in the retrieved subset 922. The use of such data fields as model input data fields facilitates the machine learning model in weighing these factors directly.

After training set builder module 918 generates training data sets 926, training set builder module 918 passes the training data sets 926 to model trainer module 930. In example embodiments, model trainer module 930 is configured to apply the model input data fields of each training data set 926 as inputs to one or more machine learning models. Each of the one or more machine learning models is programmed to produce, for each training data set 926, at least one output intended to correspond to, or “predict,” a value of the at least one result data field of the training data set 926. “Machine learning” refers broadly to various algorithms that may be used to train the model to identify and recognize patterns in existing data in order to facilitate making predictions for subsequent new input data.

Model trainer module 930 is configured to compare, for each training data set 926, the at least one output of the model to the at least one result data field of the training data set 926, and apply a machine learning algorithm to adjust parameters of the model in order to reduce the difference or “error” between the at least one output and the corresponding at least one result data field. In this way, model trainer module 930 trains the machine learning model to accurately predict the value of the at least one result data field. In other words, model trainer module 930 cycles the one or more machine learning models through the training data sets 926, causing adjustments in the model parameters, until the error between the at least one output and the at least one result data field falls below a suitable threshold, and then uploads at least one trained machine learning model 928 to AI/ML model 916 for application, to generate recommendations 932. In exemplary embodiments, model trainer module 930 may be configured to simultaneously train multiple candidate machine learning models and to select the best performing candidate for each result data field, as measured by the “error” between the at least one output and the corresponding result data field, to upload to AI/ML model 916. This may be done in or in conjunction with offline system 228.

In certain embodiments, the one or more machine learning models may include one or more neural networks, such as a convolutional neural network, a deep learning neural network, or the like. The neural network may have one or more layers of nodes, and the model parameters adjusted during training may be respective weight values applied to one or more inputs to each node to produce a node output. In other words, the nodes in each layer may receive one or more inputs and apply a weight to each input to generate a node output. The node inputs to the first layer may correspond to the model input data fields, and the node outputs of the final layer may correspond to the at least one output of the model, intended to predict the at least one result data field. One or more intermediate layers of nodes may be connected between the nodes of the first layer and the nodes of the final layer.

As model trainer module 930 cycles through the training data sets 926, model trainer module 930 applies a suitable (e.g., backpropagation) algorithm to adjust the weights in each node layer to minimize the error between the at least one output and the corresponding result data field. In this fashion, the machine learning model is trained to produce output that reliably predicts the corresponding result data field. Alternatively, the machine learning model may have any suitable structure.

In some embodiments, model trainer module 930 provides an advantage by automatically discovering and properly weighting complex, second- or third-order, and/or otherwise nonlinear interconnections between the model input data fields and the at least one output. Absent the machine learning model, such connections are unexpected and/or undiscoverable by human analysts.

The velocity analysis computing system 106 of the present disclosure is configured to operate on input data related to financial transactions, access additional data, and generate labels identifying fraudulent and non-fraudulent transactions. In one exemplary embodiment, the velocity analysis computing system 106 executes the AI/ML model 916 programmed to learn, without limitation, outcomes of transactions' labeling based upon varying events and details, relevant data sources for evidence, the queries used to prompt a user to provide relevant information, features of financial transactions related to potential fraud, and the like.

To facilitate this learning, the velocity analysis computing system 106 includes one or more databases (including transaction database 902) in which the data, including requests, responses, feature codes, evidence, outcomes, etc., is stored. This data becomes one or more input training sets used by the training set builder 918. Model outputs can be formatted for presentation or review as visual representations of recommendations, as text-based or natural language recommendations, and the like, for usability by a human reviewer (e.g., user) of the velocity analysis computing system 106. In exemplary embodiments, AI/ML model 916 may compare feedback, and may route a comparison result 934 generated by comparing recommendations 932 to the feedback to a model updater module 936 of the velocity analysis computing system 106. Model updater module 936 is configured to derive a correction signal 938 from comparison results 934 received for one or more recommendations and to provide correction signal 938 to model trainer module 930 to enable updating or “re-training” of the at least one machine learning model to improve performance. The retrained at least one machine learning model 928 may be periodically re-uploaded to AI/ML model 916.

The calculations resulting from velocity algorithm module 914 (and/or parameters of AI/ML model 916) may be output via an output module 940, which is configured to output the generated velocities for analyzing and/or categorizing transactions, and/or to further train an associated model (e.g., AI/ML model 916). Additionally, recommendations 932 from AI/ML model 916 may be output from output module 940 to user computer 224 so that a user of user computer 224 may review and implement any updates or improvements to aspects of velocity analysis computing system 106 based on an output of output module 940, in particular updates or improvements to AI/ML model 916 and/or velocity algorithm 914. Recommendations 932 (or other outputs from AI/ML model 916) may also be output to offline system 228 for evaluation in/by offline system 228 as described herein.

Velocity analysis computing system 106 may be configured to be in communication with one or more client sub-systems 222, where the client sub-systems 222 are configured to perform parallel processing as described herein. In some further embodiments, one or more of client sub-systems 222 and/or velocity analysis computing system 106 may be virtual computer devices, where some of all of the virtual computer devices are all hosted by the same computer device. In some other embodiments, client sub-systems 202, 204 (both shown in FIG. 2) may also provide parallel processing assistance in connection with processing tasks of velocity analysis computing system 106 and distributed computing system 222, such as velocity calculations.

Transaction database 902 may include all transactions associated with a merchant 108 and/or an issuer 110 over a predetermined period of time (e.g., a year to 18 months). In some embodiments, transaction database 902 is part of velocity analysis computing system 106. In other embodiments, transaction database 902 is separate from velocity analysis computing system 106 but operatively coupled thereto. Transaction database 902 may be integrated within database 212 or separate therefrom, but nevertheless operatively coupled to database 212, such that transaction data can be stored and retrieved. Transaction database 902 may also be integrated within a storage device of platform 200, such as storage device 220 (shown in FIG. 2).

Each module 904, 906, 908, 910, 912, 914, 918, 930, 936, and 940 may be code (e.g., a software module) configured within velocity analysis computing system 106 and/or distributed computing system 222, for example to take advantage of parallel processing, and may be arranged in individual or combined configurations.

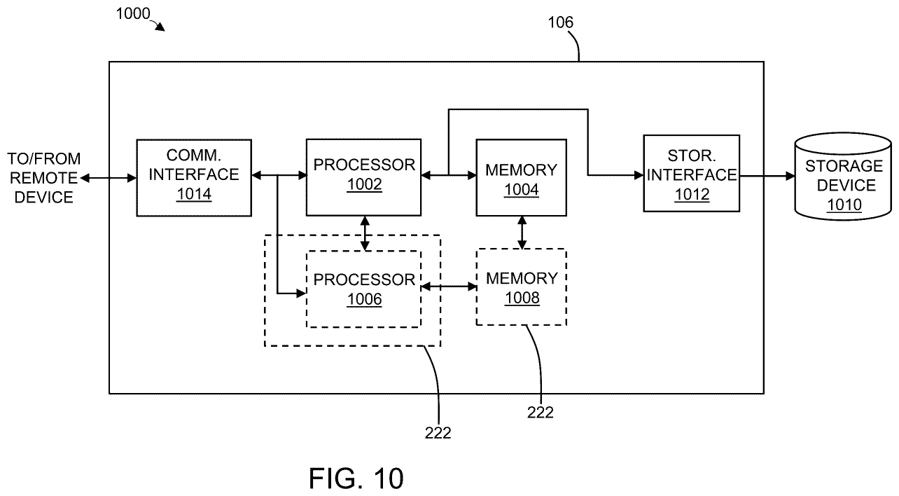

FIG. 10 illustrates an example configuration 1000 of velocity analysis computing system 106 in accordance with one example embodiment of the present disclosure. Configuration 1000 of velocity analysis computing system 106 may include a processor 1002 operatively coupled with a memory 1004. In some embodiments, velocity analysis computing system 106 may include one or more additional processors 1006 operatively coupled with one or more additional memories 1008, where the processors 1002, 1006 and memories 1004, 1008 may be operatively coupled with one another, and may be configured to provide parallel computing functions (e.g., to assist with resource heavy computing tasks). Additional processors 1006 and additional memories 1008 may be integrated with velocity analysis computing system 106, or may be integrated with one or more other (e.g., external) computing systems such as distributed computing systems 222 that is/are operatively coupled with velocity analysis computing system 106. Configuration 1000 of velocity analysis computing system 106 may also include a storage device 1010 configured to store data, and be accessible via storage interface 1012. While storage device 1010 is shown in FIG. 10 as being external to velocity analysis computing system 106, storage device 1010 may be integrated with velocity analysis computing system 106. Storage device 1010 may be embodied as storage device 220 shown in FIG. 2 (or vice versa, where storage device 220 may have a storage interface that is the same as or similar to storage interface 1012)), or other storage devices within platform 200. Velocity analysis computing system 106 may communicate (e.g., via network 206) with other devices (e.g., remote devices) within platform 200 as shown in FIG. 2 via a communication interface 1014.

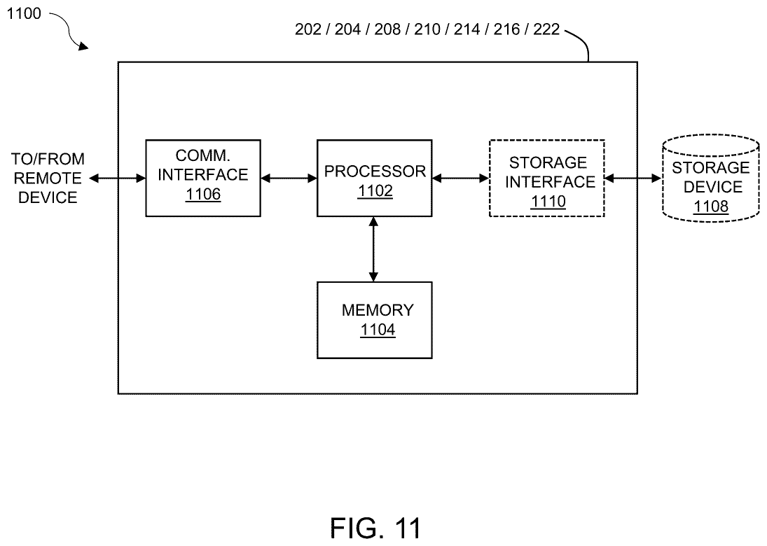

FIG. 11 illustrates an example configuration 1100 of the various client computing devices (e.g., 202, 204, 222) and/or server devices (e.g., 208, 210, 214, 216) in accordance with one example embodiment of the present disclosure. Configuration 1100 includes a processor 1102 operatively coupled with a memory 1104. The various devices (e.g., 202, 204, 222, and/or 208, 210, 214, 216) may communicate with other devices (e.g., remote devices) within platform 200 shown in FIG. 2 via a communication interface 1106 operatively coupled to processor 1102. In some embodiments, processor 1102 is operatively coupled to storage device 1108 via a storage interface 1110, to access or store data within storage device 1108. Storage device 1108 may be standalone storage or embodied as any storage device within platform 200 as described herein.

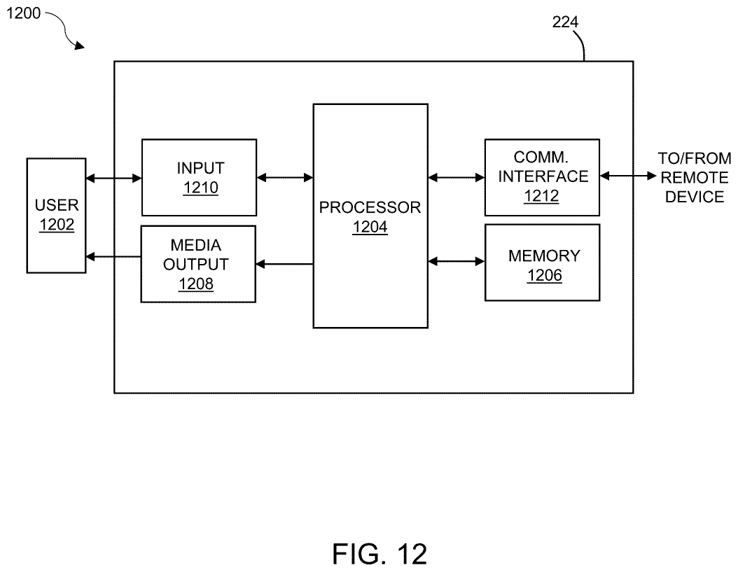

FIG. 12 illustrates an example configuration 1200 of user computing device 224 used in conjunction with velocity analysis computing system 106 within platform 200, so that a user 1202 may review the output from velocity analysis computing system 106, for example. In this regard, the output module 940 shown in FIG. 9 may output results from the velocity calculations and other processes performed by velocity analysis computing system 106 in a user-readable format for presentation to the user 1202, so that the user 1202 may analyze the results (e.g., for purposes of verifying the accuracy of the velocity calculation algorithm and/or model 916, such as for updating the model 916, etc.). User 1202 may be an employee of the entity that owns and/or operates velocity analysis computing system 106, for example. Configuration 1200 includes a processor 1204 operatively coupled with a memory 1206. User computing device 224 further includes a communication interface 1212 so that user computing device 224 may communicate with other computing devices (e.g., remote devices) within platform 200 shown in FIG. 2. User computing device 224 also includes at least one media output component 1208 for presenting information to user 1202. In some embodiments, media output component 1208 includes an output adapter such as a video adapter and/or an audio adapter. An output adapter is operatively coupled to processor 1204 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones). In some embodiments, user computing device 224 includes an input device 1210 for receiving input from user 1202. Input device 1210 may include, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen may function as both an output device of media output component 1208 and input device 1210.

Each of the processors (e.g., 1002, 1006, 1102, 1204) described in connection with FIGS. 10-12 may be configured to execute instructions that may be stored in the corresponding memories (e.g., 1004, 1008, 1104, 1206) shown in and described in connection with FIGS. 10-12, for example. The processors may include one or more processing units (e.g., in a multi-core configuration) for executing instructions, and may be configured to operate in a parallel processing environment as described herein. The instructions may be executed within a variety of different operating systems on the respective systems, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.). The memories may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

Each of the storage devices (e.g., 1010, 1108) shown in and described in connection with FIGS. 10 and 11 may include one or more computer-readable media, such as one or more hard disk drives or solid state disks in a redundant array of inexpensive disks (RAID) configuration, and further may include a storage area network (SAN) and/or a network attached storage (NAS) system. Each of the storage interfaces (e.g., 1012, 1110) shown in and described in connection with FIGS. 10 and 11 may be any component capable of providing the processors with access to the storage devices. Storage interfaces may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processors with access to the storage devices.

Each of the various communication interfaces (e.g., 1014, 1106, 1212) shown in and described in connection with FIGS. 10-12 may be communicatively couplable to a remote device such as a server system (e.g., 208, 210, 214, 216) or a web server, and may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)). For example, communication interface 1014 may receive data from payment network server 208 and/or issuer system 204 via the Internet, as illustrated in FIG. 2.

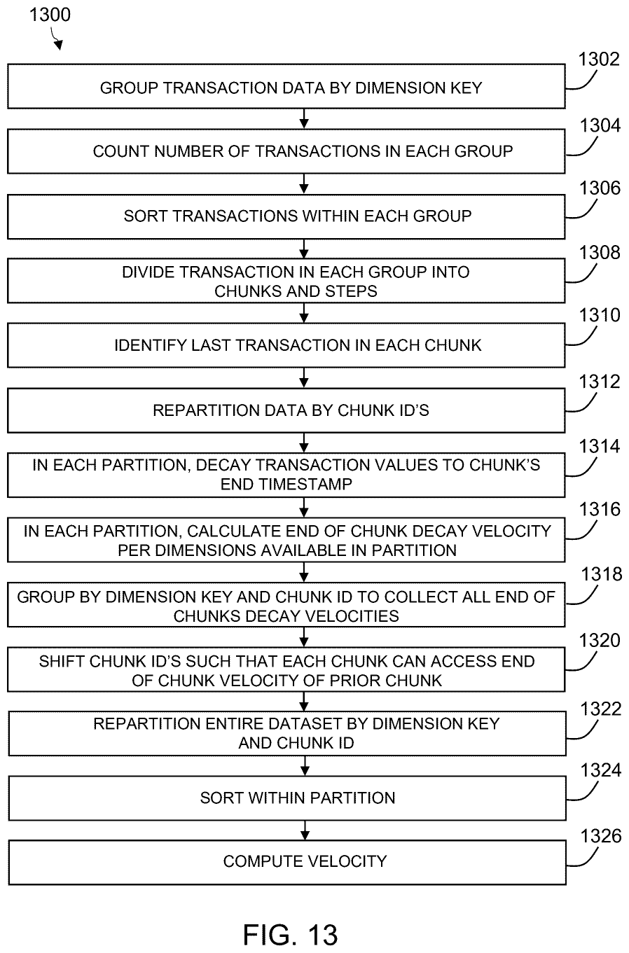

FIG. 13 illustrates an example process flow 1300 for processing one or more transactions with velocity analysis computing system 106 in accordance with one example embodiment of the present disclosure, namely the embodiment of FIGS. 3-6, and may be defined as being representative of an algorithm of the embodiment of FIGS. 3-6. The steps of process flow 1300 include: grouping 1302 the transaction data (e.g., from transaction database 902) by the dimension key; counting 1304 the number of transactions in each group; sorting 1306 the transactions within each group (e.g., by dimension key); depending on the number of dimension keys and framework partition size, dividing 1308 the transactions in each group into chunks and steps; identifying 1310 the last transaction in each chunk to detect the end of chunk timestamp; repartitioning 1312 the data by chunk IDs; within each partition (e.g., partitions 406, 408, 410), decaying 1314 transaction values to the chunk's end timestamp and calculating 1316 the end of chunk decay velocity per dimensions available in the partition; grouping 1318 by dimension key and chunk ID to collect all the end of chunks decay velocities; shifting 1320 chunk IDs such that each chunk can access the end of chunk velocity of prior chunk; repartitioning 1322 the entire dataset by dimension key and chunk ID; sorting 1324 within the partition; and then computing 1326 the velocity.

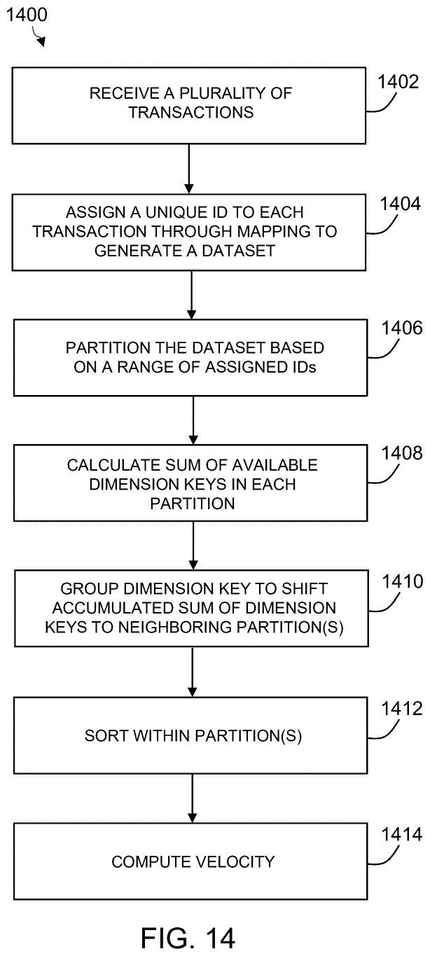

FIG. 14 illustrates an example process flow 1400 for a transaction processed in connection with velocity analysis computing system 106 in accordance with one example embodiment of the present disclosure, namely the (preferred) embodiment of FIGS. 7 and 8, and may be defined as being representative of an algorithm of the embodiment of FIGS. 7 and 8. Process flow 1400 includes the steps of: receiving 1402 a plurality of transactions (e.g., from transaction database 902); assigning 1404 a ChronoID to each transaction through mapping to generate a dataset; partitioning 1406 the dataset based on a range of assigned IDs.; through mapping within a partition (e.g., partitions 806, 808, 810), calculating 1408 the sum of available dimensions in each partition; grouping 1410 the dimension key to shift the accumulated sum of dimensions to neighboring partitions; sorting 1412 within partitions; and computing 1414 the velocity. This provides a streamlined approach to calculating decay velocities without the need for complex data manipulation steps, as described herein. Comparing FIG. 14 with FIG. 13 shows that process flow 1400 contains significantly less steps than process flow 1300. More specifically, process flow 1400 may include the steps of: assign a ChronoID to each transaction of the one or more transactions; generate a dataset based on the assigned ChronoIDs; arrange the dataset into a plurality of subsets within the one or more partitions, wherein each subset of the plurality of subsets represents a range of the assigned ChronoIDs; calculate a sum of dimension keys present in each partition of the one or more partitions; group the summed dimension keys to shift an accumulated sum of the dimension keys to one or more neighboring partitions that neighbor at least one partition of the one or more partitions; sort the accumulated sums within the one or more neighboring partitions; compute one or more velocities of the sorted accumulated sums; and output the computed one or more velocities for use in characterizing the one or more transactions within the payment network.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are exemplary only, and are thus not limiting as to the types of memory usable for storage of a computer program.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, e.g., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications or code) include machine instructions for a programmable processor and can be implemented in a high-level procedural and/or object-oriented programming language, and/or in assembly/machine language. As used herein, the terms “machine-readable storage medium” and “computer-readable storage medium” refer to any computer program product, apparatus and/or device (e.g., magnetic discs, optical disks, memory, Programmable Logic Devices (PLDs)) used to provide machine instructions and/or data to a programmable processor, including a machine-readable storage medium that receives machine instructions as a machine-readable signal. The term “machine-readable signal” refers to any signal used to provide machine instructions and/or data to a programmable processor. The machine-readable storage medium and computer-readable medium do not include transitory signals.

The above-described embodiments of a method and system of computing velocities in an efficient manner within a distributed computing systems framework provides a cost-effective and time-saving means for analyzing a high volume of transaction data in payment network platforms. As a result, the methods and systems described herein facilitate leveraging a payment network's assets to improve analysis of data contained within the network, to thereby improve the quality of data within the network.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer system for calculating a decay velocity comprising:
one or more storage devices including one or more partitions defined therein;
a computing device comprising at least one processor in communication with at least one memory device and the one or more storage devices, wherein the at least one processor is programmed to:
receive transaction data for one or more transactions of a cardholder initiated using a payment processing network;
process the transaction data for the one or more transactions by mapping the transaction data within the one or more partitions including:
assign an identification (ID) to each transaction of the one or more transactions;
generate a dataset based on the assigned IDs;
arrange the dataset into a plurality of subsets within the one or more partitions, wherein each subset of the plurality of subsets represents a range of the assigned IDs;
calculate a sum of a selected dimension key present in each partition of the one or more partitions;
calculate an accumulated sum by combining each sum of the selected dimension key in each partition;
compute one or more decay velocities of the accumulated sum for the selected dimension key; and
output the one or more decay velocities for the selected dimension key representing the one or more transactions.

2. A system in accordance with claim 1, wherein said at least one processor is further programmed to:
compute the one or more decay velocities according to a velocity formula, the velocity formula comprising
$${v}_{n} = \frac{{\sum }_{i = 0}^{n} {e}^{- α ( T - {t}_{i} ) + log ( {x}_{i} )}}{{e}^{- α ( T - {t}_{n} )}} ,$$
where νₙ represents a velocity at a transaction n within the one or more transactions.

3. A system in accordance with claim 2, wherein the velocity formula includes a time quantity T, the time quantity T representing an arbitrary and universal time for all transactions and dimension keys.

4. A system in accordance with claim 1, wherein the computing device is associated with one or more distributed computing devices, the one or more distributed computing devices being part of a distributed computing system, the distributed computing system being operatively coupled to the computing device.

5. A system in accordance with claim 4, wherein the one or more distributed computing devices includes one or more distributed processors.

6. A system in accordance with claim 5, wherein the one or more distributed processors include a first distributed processor and a second distributed processor, the one or more distributed computing devices includes a first distributed computing device and a second distributed computing device, the first distributed processor is provided within the first distributed computing device, the second distributed processor is provided within the second distributed computing device, and the calculation of each sum of the dimension key present in each partition of the one or more partitions is distributed between the first distributed computing device and the second distributed computing device.

7. A system in accordance with claim 6, wherein the first distributed processor and the second distributed processor system are arranged in a parallel processing configuration for calculating the one or more decay velocities according to a velocity formula, the velocity formula comprising
$${v}_{n} = \frac{{\sum }_{i = 0}^{n} {e}^{- α ( T - {t}_{i} ) + log ( {x}_{i} )}}{{e}^{- α ( T - {t}_{n} )}} ,$$
where νₙ represents a velocity at a transaction n within the one or more transactions.

8. A system in accordance with claim 1, wherein the at least one processor is programmed to execute a machine learning model, the machine learning model being trained at least on historical transaction data within the payment network.

9. A system in accordance with claim 1, wherein the one or more partitions includes one or more preceding partitions, and the transaction data is chronologically organized within each partition of the one or more partitions such that the transaction data is chronologically equal to or preceding transaction data in at least one preceding partition of the one or more preceding partitions.

10. A system in accordance with claim 1, wherein the at least one processor is further programmed to:
characterize the one or more transactions, including performing a fraud analysis; and
operate as a velocity engine to identify, as part of the fraud analysis and based on the computed one or more decay velocities, potentially fraudulent transactions associated with a credit card number of the cardholder.

11. A system in accordance with claim 1, wherein to process the transaction data for the one or more transactions, the at least one processor is further programmed to:
group each selected dimension key sum in one or more neighboring partitions that neighbor at least one partition of the one or more partitions; and
sort the accumulated sum for the selected dimension key within the one or more neighboring partitions.

12. A computer-implemented method for calculating a decay velocity implemented using at least one processor in communication with at least one memory, the method comprising:
defining one or more partitions in the at least one memory;
receiving transaction data for one or more transactions of a cardholder initiated using a payment processing network;
processing the transaction data for the one or more transactions by mapping the transaction data within the one or more partitions including:
assigning an identification (ID) to each transaction of the one or more transactions;
generating a dataset based on the assigned IDs;
arranging the dataset into a plurality of subsets within the one or more partitions, wherein each subset of the plurality of subsets represents a range of the assigned IDs;
calculating a sum of a selected dimension key present in each partition of the one or more partitions;
calculating an accumulated sum by combining each sum of the selected dimension key in each partition;
computing one or more decay velocities of the accumulated sum for the selected dimension key; and
outputting the one or more decay velocities for the selected dimension key representing the one or more transactions.

13. A method in accordance with claim 12, further comprising:
computing the one or more decay velocities according to a velocity formula, the velocity formula comprising
$${v}_{n} = \frac{{\sum }_{i = 0}^{n} {e}^{- α ( T - {t}_{i} ) + log ( {x}_{i} )}}{{e}^{- α ( T - {t}_{n} )}} ,$$
where νₙ represents a velocity at a transaction n within the one or more transactions.

14. A method in accordance with claim 12, further comprising executing a machine learning model, the machine learning model being trained at least on historical transaction data within the payment network.

15. A method in accordance with claim 12, further comprising:
grouping each selected dimension key sum in one or more neighboring partitions that neighbor at least one partition of the one or more partitions; and
sorting the accumulated sum for the selected dimension key within the one or more neighboring partitions.

16. One or more non-transitory computer-readable storage media with instructions stored thereon that, in response to being executed, cause a computer system for calculating a decay velocity to:
define one or more partitions in one or more storage devices;
receive transaction data for one or more transactions of a cardholder initiated using a payment processing network;
process the transaction data for the one or more transactions by mapping the transaction data within the one or more partitions including:
assign an identification (ID) to each transaction of the one or more transactions;
generate a dataset based on the assigned IDs;
arrange the dataset into a plurality of subsets within the one or more partitions, wherein each subset of the plurality of subsets represents a range of the assigned IDs;
calculate a sum of a selected dimension key present in each partition of the one or more partitions;
calculate an accumulated sum by combining each sum of the selected dimension key in each partition;
compute one or more decay velocities of the accumulated sum for the selected dimension key; and
output the one or more decay velocities for the selected dimension key representing the one or more transactions.

17. One or more non-transitory computer-readable storage media in accordance with claim 16, wherein the instructions, in response to being executed, further cause the computer system to:
compute the one or more decay velocities according to a velocity formula, the velocity formula comprising
$${v}_{n} = \frac{{\sum }_{i = 0}^{n} {e}^{- α ( T - {t}_{i} ) + log ( {x}_{i} )}}{{e}^{- α ( T - {t}_{n} )}} ,$$
where νₙ represents a velocity at a transaction n within the one or more transactions.

18. One or more non-transitory computer-readable storage media in accordance with claim 16,
wherein the instructions, in response to being executed, further cause the computer system to execute a machine learning model, the machine learning model being trained at least on historical transaction data within the payment network.

19. One or more non-transitory computer-readable storage media in accordance with claim 16, wherein the instructions, in response to being executed, further cause the computer system to:
characterize the one or more transactions, including performing a fraud analysis; and
operate as a velocity engine to identify, as part of the fraud analysis and based on the computed one or more decay velocities, potentially fraudulent transactions associated with a credit card number of the cardholder.

20. One or more non-transitory computer-readable storage media in accordance with claim 16, wherein to process the transaction data for the one or more transactions, the instructions, in response to being executed, further cause the computer system to:
group each selected dimension key sum in one or more neighboring partitions that neighbor at least one partition of the one or more partitions; and
sort the accumulated sum for the selected dimension key within the one or more neighboring partitions.
